(19) United States
(12) Patent Application Publication
(10) Pub. No.: US 2025/0159714 A1
(43) Pub. Date: May 15, 2025

(54) INSTANTANEOUS UE SI MEASUREMENT AND REPORTING

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/506,844

(22) Filed: Nov. 10, 2023

(51) Int. Cl. H04W 72/541; H04L 5/00; H04L 5/16; H04W 88/06

(52) U.S. Cl. CPC H04W 72/541; H04L 5/0005; H04L 5/16; H04W 88/06

(57) ABSTRACT

A method for wireless communication at a user equipment (UE) and related apparatus are provided. In the method, the UE receives an SBFD time and frequency configuration allocating resources for communication with a network entity based on an SBFD mode, and obtains a UE operation mode for the resources. The UE operation mode is one of a UE FD mode or a UE HD mode. The UE further communicates with the network entity in the resources allocated for the UE based on the UE operation mode.

### TECHNICAL FIELD

The present disclosure relates generally to communication systems, and more particularly, to user equipment (UE) self-interference (SI) measurement and reporting in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive a subband full duplex (SBFD) time and frequency configuration allocating resources for communication with a network entity based on an SBFD mode; obtain a UE operation mode for the resources, wherein the UE operation mode is one of a UE full-duplex (FD) mode or a UE half-duplex (HD) mode; and communicate with the network entity in the resources allocated for the UE based on the UE operation mode.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit an SBFD time and frequency configuration allocating resources for communication with a UE based on an SBFD mode; and communicate with the UE in the resources allocated for the UE based on a UE operation mode for the resources. The UE operation mode is one of a UE FD mode or a UE HD mode.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIGS. 4A, 4B, 4C, and 4D illustrate various modes of full duplex communication.

FIG. 5 illustrates examples of in-band full-duplex (IBFD) resources and sub-band full-duplex (SBFD) resources.

FIG. 6 is a diagram illustrating an example of the network SBFD operation.

FIG. 7A is a diagram illustrating a UE operation mode in accordance with various aspects of the present disclosure.

FIG. 7B is a diagram illustrating a UE operation mode in accordance with various aspects of the present disclosure.

FIG. 7C is a diagram illustrating a UE operation mode in accordance with various aspects of the present disclosure.

FIG. 7D is a diagram illustrating a UE operation mode in accordance with various aspects of the present disclosure.

FIG. 8 is a diagram illustrating an example UE SBFD configuration based on UE traffic in accordance with various aspects of the present disclosure.

FIG. 9 is a diagram illustrating UE operating in SBFD mode and HD mode at different symbols in accordance with various aspects of the present disclosure.

FIG. 10 is a diagram illustrating an example indication of the UE mode in accordance with various aspects of the present disclosure.

FIG. 11 is a diagram illustrating an example indication of UE modes in accordance with various aspects of the present disclosure

FIG. 12 is a call flow diagram illustrating a method of wireless communication in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a UE in accordance with various aspects of the present disclosure.

FIG. 16 is a flowchart illustrating methods of wireless communication at a UE in accordance with various aspects of the present disclosure.

FIG. 17 is a flowchart illustrating methods of wireless communication at a network entity in accordance with various aspects of the present disclosure.

FIG. 18 is a flowchart illustrating methods of wireless communication at a network entity in accordance with various aspects of the present disclosure.

FIG. 19 is a flowchart illustrating methods of wireless communication at a network entity in accordance with various aspects of the present disclosure.

FIG. 20 is a flowchart illustrating methods of wireless communication at a network entity in accordance with various aspects of the present disclosure.

FIG. 21 is a diagram illustrating an example of a hardware implementation for an example apparatus and/or network entity.

FIG. 22 is a diagram illustrating an example of a hardware implementation for an example network entity.

### DETAILED DESCRIPTION

In wireless communication, subband full duplex (SBFD) communication enables one device to both transmit and receive in a same frequency range at a same time. As an example, a base station (e.g., a gNB or other type of base station) may serve one or more user equipment (UE) in both downlink (DL) and uplink (UL) simultaneously within corresponding subbands. However, when SBFD-capable base stations configure a UE to transmit in UL subbands and receive in DL subbands within the same time-frequency resource, the self-interference (SI) can degrade the system's performance. Example aspects presented herein provide methods and apparatus that enable instantaneous self-interference measurement and reporting by the UEs. The methods ensure that UEs can adapt their operation modes in real-time, switching between half-duplex (HD) and full-duplex (FD) modes to maintain optimal performance.

Various aspects relate generally to wireless communication. Some aspects more specifically relate to instantaneous UE SI measurement and reporting in wireless communication. Some aspects relate to different modes of UE operation for resources allocated as SBFD resources. For example, a UE may communicate in a half-duplex mode, while the base station transmits and receives in the SBFD resources. In other examples, the UE may communicate in a full-duplex mode in the SBFD resources. In some examples, a UE receives an SBFD time and frequency configuration allocating resources for communication with a network entity based on an SBFD mode; obtains a UE operation mode for the resources, wherein the UE operation mode is one of a UE FD mode or a UE HD mode; and communicates with the network entity in the resources allocated for the UE based on the UE operation mode. In some examples, a UE receives a time and frequency configuration allocating resources for communication with a network entity based on an FD operation. The UE operates in one of a UE HD mode or a UE FD mode in the resources. The UE further performs, in response to the time and frequency configuration, an SI measurement for the UE, and reports, to the network entity, an SI indication indicating the SI measurement.

Particular aspects of the subject matter described in this disclosure can be implemented to realize one or more of the following potential advantages. In some examples, enabling different modes of operation, the described techniques allow UEs to interact flexibly with various cell types and configurations to improve the efficiency of resource utilization. In some examples, by enabling the UE to measure the SI and report the results to the network following an operation mode indication, the described techniques allow for quick adjustments in operational parameters, such as antenna configurations and transmission powers, to optimize its performance based on real-time conditions such as traffic demand or signal interference, thereby ensuring communication reliability and maintaining optimal performance. In some examples, by incorporating the SI information in the beam management report or feedback, the described techniques enable UEs to select the most appropriate DL and UL beam pairs, thereby enhancing the reliability of FD operations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

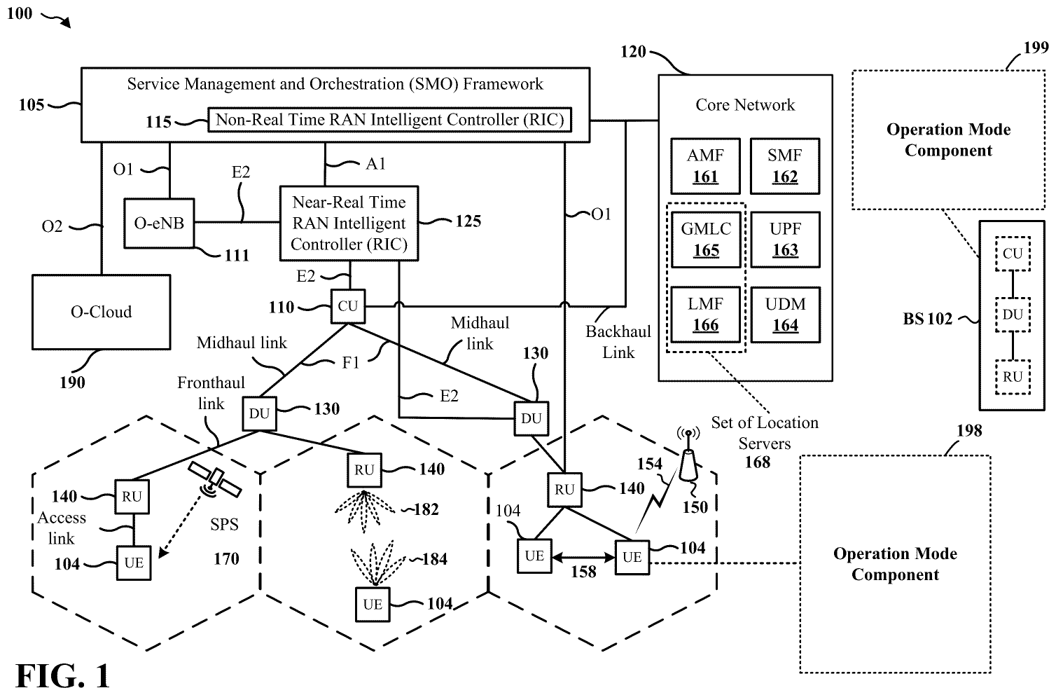

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an operation mode component 198. In some aspects, the operation mode component 198 may be configured to receive an SBFD time and frequency configuration allocating resources for communication with a network entity based on an SBFD mode; obtain a UE operation mode for the resources, wherein the UE operation mode is one of a UE FD mode or a UE HD mode; and communicate with the network entity in the resources allocated for the UE based on the UE operation mode. In some aspects, the operation mode component 198 may be configured to receive a time and frequency configuration allocating resources for communication with a network entity based on an FD operation, where the UE operates in one of a UE HD mode or a UE FD mode in the resources; perform, in response to the time and frequency configuration, an SI measurement for the UE; and report, to the network entity, an SI indication indicating the SI measurement. In certain aspects, the base station 102 may include an operation mode component 199. In some aspects, the operation mode component 199 may be configured to transmit an SBFD time and frequency configuration allocating resources for communication with a UE based on an SBFD mode; and communicate with the UE in the resources allocated for the UE based on a UE operation mode for the resources, where the UE operation mode is one of a UE FD mode or a UE HD mode. In some aspects, the operation mode component 199 may be configured to transmit a time and frequency configuration allocating resources for communication with a UE based on an FD operation, where the UE operates in one of a UE HD mode or a UE FD mode in the resources; and receive, from the UE, an SI indication indicating an SI measurement on the UE. Although the following description may be focused on 5G NR, the concepts described herein may be applicable to other similar areas, such as LTE, LTE-A, CDMA, GSM, and other wireless technologies.

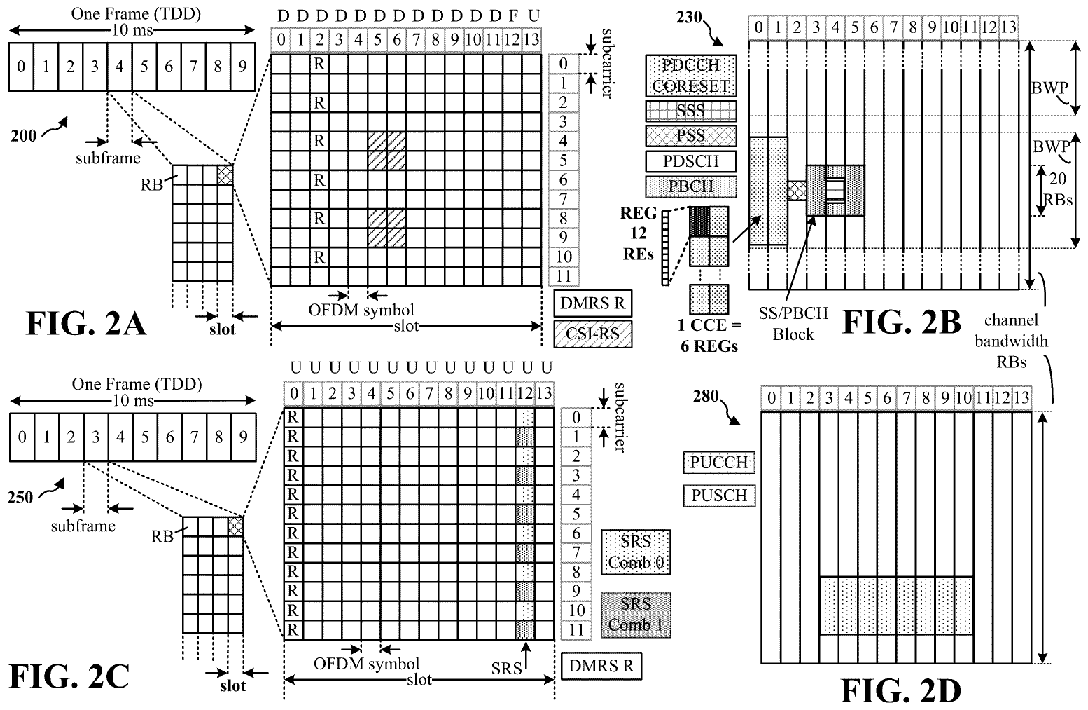

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 1 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

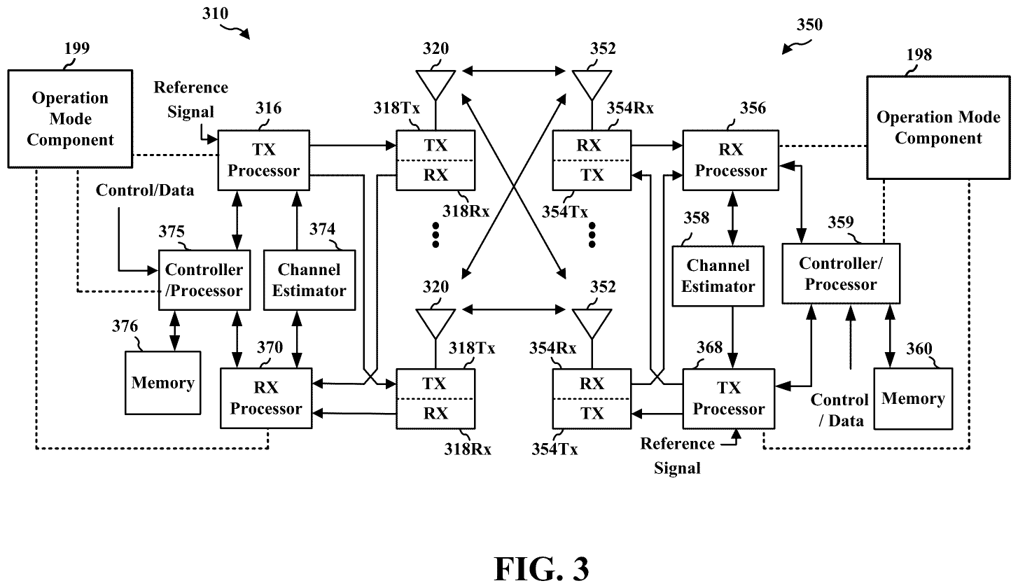

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the operation mode component 198 of FIG. 1.

At least one of the TX processor 316, the RX processor 370, and the controller/processor 375 may be configured to perform aspects in connection with the operation mode component 199 of FIG. 1.

Example aspects presented herein provide methods and apparatus for the interaction between SBFD network operation with HD UE and SBFD UE operations, including detailed signals for different combinations of UE and network SBFD operations.

Wireless communication systems may be configured to share available system resources and provide various telecommunication services (e.g., telephony, video, data, messaging, broadcasts, etc.) based on multiple-access technologies that support communication with multiple users. Full duplex operation in which a wireless device exchanges uplink and downlink communication that overlaps in time may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. For example, full duplex operation may enable a UE to receive a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

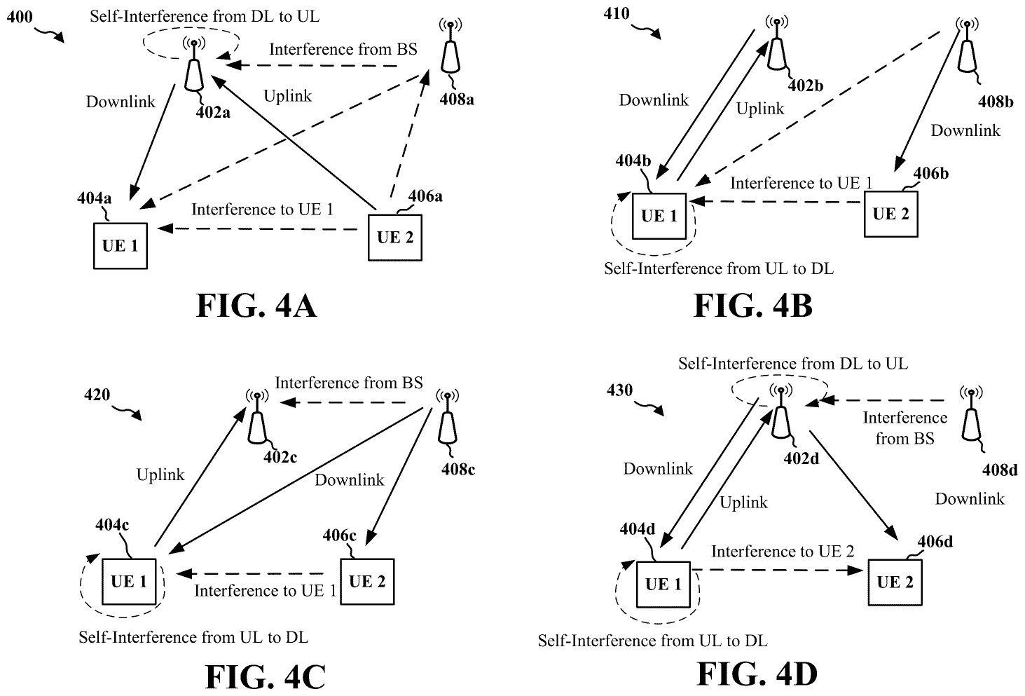

FIGS. 4A-4C illustrate various modes of full duplex communication. Full duplex communication supports transmission and reception of information over the same frequency band in a manner that overlaps in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows a second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in the same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

FIG. 4D shows a fourth example of full-duplex communication 430 in which a first base station 402d employs full-duplex communication with a first UE 404d, and transmits downlink communication to a second UE 406d. In this example, the first UE 404d is operating in a full-duplex mode, and the second UE 406d is operating in a half-duplex mode. The first base station 402d and the first UE 404d receive and transmit communication that overlaps in time and is in the same frequency band. The base station 402d and the first UE 404d may each experience self-interference, due to a transmitted signal from the corresponding device leaking to (e.g., being received by) a receiver at the same device. The base station 402d may further experience cross link interference due to a signal transmitted by the base station 408d. The second UE 406d may experience cross-link interference from the uplink transmission of the first UE 404b when receiving downlink communication from the base station 402d.

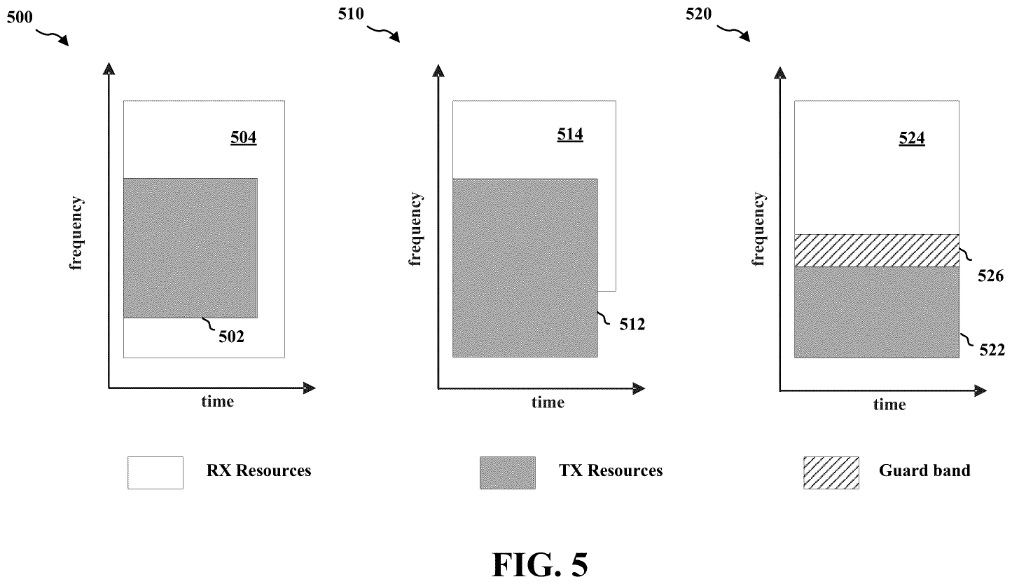

Full duplex communication may be in the same frequency band. The uplink and downlink communication may be in different frequency sub-bands, in the same frequency sub-band, or in partially overlapping frequency sub-bands. FIG. 5 illustrates a first example 500 and a second example 510 of in-band full-duplex (IBFD) resources and a third example 520 of sub-band full-duplex resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to sub-band FDD, where transmission and reception resources may overlap in time using different frequencies, as shown in the third example 520. In the third example 520, the UL, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 502, 512, and 522 may correspond to uplink resources, and the reception resources 504, 514, and 524 may correspond to downlink resources. Alternatively, if the full-duplex operation is for a base station or a device implementing base station functionality, the transmission resources 502, 512, and 522 may correspond to downlink resources, and the reception resources 504, 514, and 524 may correspond to uplink resources.

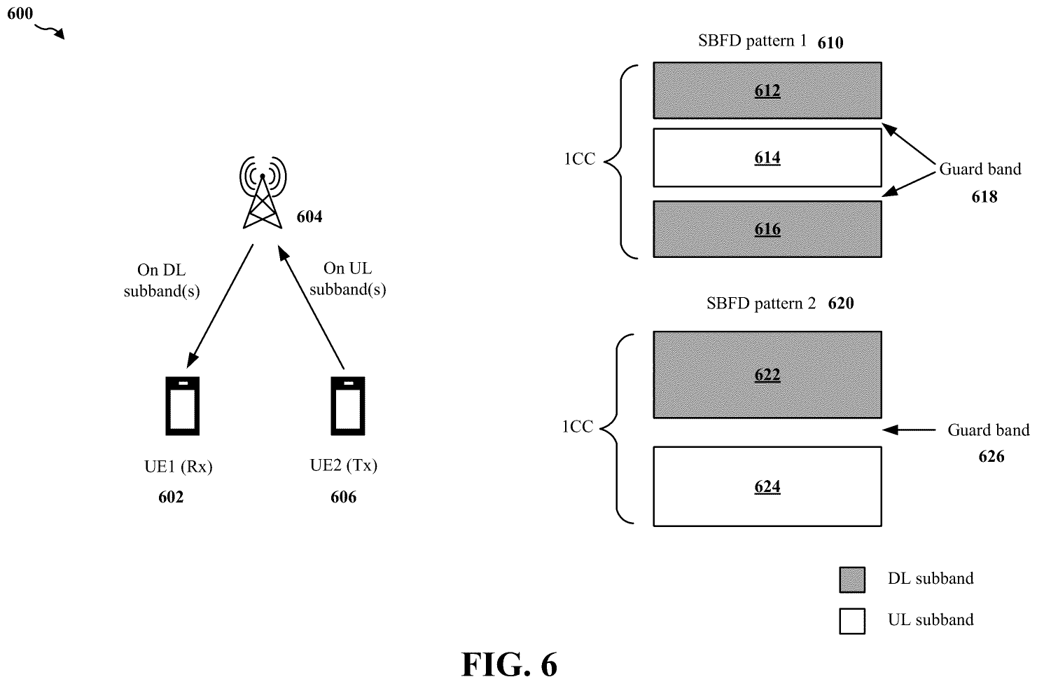

At the network side, SBFD operation allows the network (e.g., a base station) to simultaneously serve UEs on both DL and UL on corresponding subbands. FIG. 6 is a diagram 600 illustrating an example of the network SBFD operation. As shown in FIG. 6, the network (e.g., base station 604) may operate in the SBFD mode and simultaneously serve one UE (UE1 602) on an DL subband and another UE (UE2 606) on a UL subband. Various subband patterns may be used for the network SBFD operation. A first example pattern (SBFD pattern 1 610) follows a D+U+D configuration, which includes a DL subband 612, a UL subband 614, and another DL subband 616. The second example pattern (SBFD pattern 2 620) utilizes a D+U configuration, which includes a DL subband 622 and a UL subband 624. To minimize interference between DL and UL subbands, one or more guard bands (e.g., guard bands 618, 626) may be provided that include a number of resource blocks (RBs) between the DL and UL subbands.

SBFD operation allows simultaneous transmitting and receiving of downlink and uplink signals on a sub-band basis. The SBFD operation may increase the UL duty cycle, resulting in reduced latency. For example, SBFD operation allows for the transmission of the UL signal in the UL subband in DL slots or flexible slots. On the other hand, SBFD operation also allows the reception of DL signals in DL subband in UL slots. These adaptations help to reduce latency. Additionally, SBFD contributes to an improvement in UL coverage, e.g., by enabling UL transmissions at the same time as DL communication. Furthermore, SBFD operation enhances the system's capacity, resource utilization, and overall spectrum efficiency, and enables dynamic and flexible UL/DL resource adaptation according to UL and DL traffic, thereby optimizing the network's performance.

In some examples, an SBFD network (e.g., an SBFD base station or a network that supports SBFD resources or SBFD operation) may operate with two HD UEs, and the symbols for HD communication and the symbols for SBFD communication may exist simultaneously, e.g., overlap in time. For example, certain symbols or slots can be semi-statically set as SBFD symbols (e.g., for base station SBFD communication) on Downlink (D) or Flexible (F) symbols, while the remaining symbols or slots may continue to be HD symbols or slots.

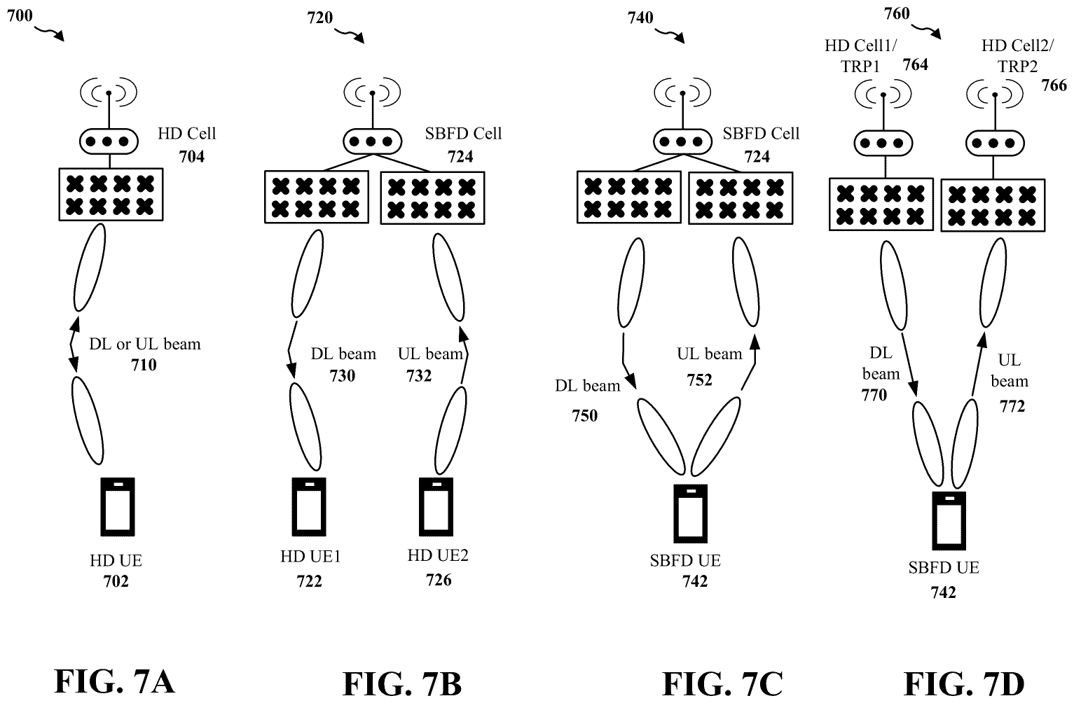

In some examples, the UE may operate in an SBFD mode, and the SBFD UE may communicate with the SBFD network to further enhance the system capacity and UL coverage, and further decrease latency. FIGS. 7A, 7B, 7C, 7D are diagrams illustrating various modes of UE operation in accordance with various aspects of the present disclosure. One or more of the modes illustrated in FIGS. 7A-7D may be configured and may co-exist in different symbols or slots. Additionally, the UE and/or the base station may be capable of switching from one mode to another mode, e.g., based on specific timing or conditional triggers. FIG. 7A is a diagram 700 illustrating a mode pairing an HD cell 704 with an HD UE 702. The HD cell 704 and the HD UE 702 may communicate via a DL or UL beam 710. FIG. 7B is a diagram 720 illustrating an SBFD network working with two HD UE. In FIG. 7B, the SBFD cell 724 may simultaneously communicate with a first HD UE (HD UE1 722) via a DL beam 730, and with a second HD UE (HD UE2 726) via a UL beam 732. FIG. 7C is a diagram 740 illustrating an SBFD network working with an SBFD UE. In FIG. 7C, the SBFD cell 724 may simultaneously transmit to an SBFD UE 742 via a DL beam 750 and receive from the SBFD UE 742 via a UL beam 752. FIG. 7D is a diagram 760 illustrating an SBFD UE communicating with two low capability HD cells/TRPs. In FIG. 7D, an SBFD UE 742 may simultaneously communicate with a first HD cell/TRP (HD Cell1/TRP1 764) via a DL beam 770 and with a second HD cell/TRP (HD Cell2/TRP2 766) via a UL beam 772. From the perspective of an SBFD UE, communicating with one SBFD cell (as in FIG. 7C) and with two HD cells (as in FIG. 7D) may be indistinguishable, thus these two modes may be transparent to the UE.

In some aspects, if a UE supports SBFD communication, an SBFD network (e.g., an SBFD base station that supports SBFD communication) may configure the UE to simultaneously transmit (Tx) in the UL subband and receive (Rx) in the DL subband within an SBFD symbol or slot. However, an SBFD network (e.g., an SBFD base station) may not to configure the UE for SBFD communication on each symbol or slot. The configuration may be flexible and may be based on a variety of conditions. For example, the UE's SBFD operation may vary depending on certain operational conditions or may be dynamic. One such operational condition may be self-interference (SI) experienced at the UE. For example, if SI at the SBFD UE becomes high enough to exceed a threshold level (e.g., due to factors such as clutter), the UE may request the network to revert to the UE to an HD mode (the network may stay in either the SBFD mode or an HD mode). Additionally, or alternatively, the UE's SBFD configuration or operation may be influenced by the traffic demand in a DL or UL direction. For example, if a UE configured grant (CG) has a larger periodicity than resources scheduled for the UE in semi-persistent scheduling (SPS), there might be occasions where the UE's SPS can be paired with another UE for SBFD operation by the network, with the UE communicating in an HD mode. At other times or occasions, the UE's SPS may be paired with its own UL CG for UE SBFD operations.

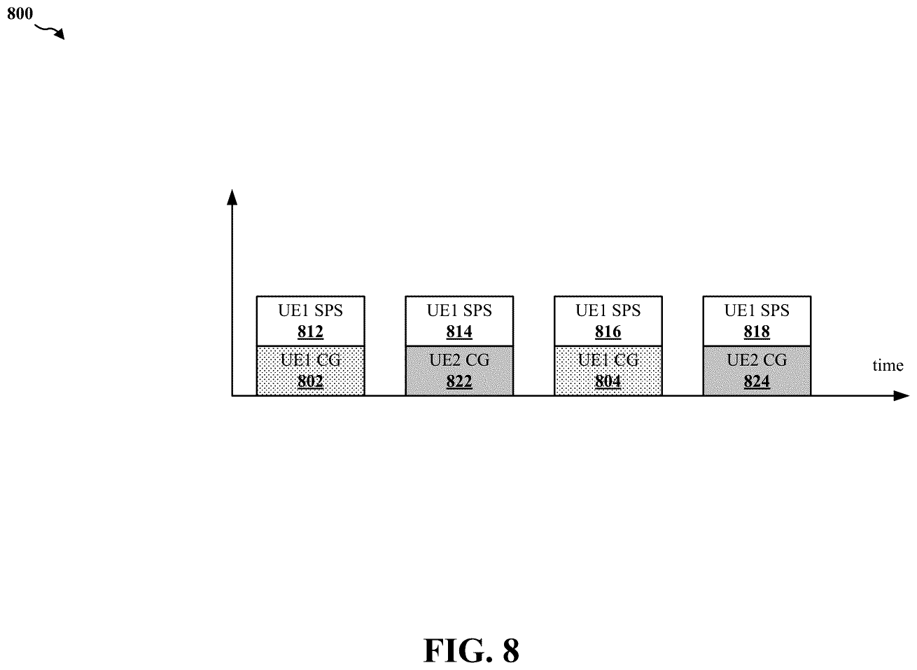

FIG. 8 is a diagram 800 illustrating an example UE SBFD configuration, or operation, based on UE traffic in accordance with various aspects of the present disclosure. FIG. 8 illustrates an example of occasions of a configured grant (CG) and semi-persistent scheduling (SPS). A configured grant provides a UE with periodic or semi-persistent resources that the UE may use for uplink transmissions to the network. For example, the network may provide one or more configured grants of recurring resources for uplink transmission in RRC signaling to the UE. For some types of configured grants, the UE may use the allocated resources based on the RRC configuration and without activation or control signaling from the network. In other types of configured grants, the UE may further receive an indication that the configured grant is activated or enabled for the UE to use, e.g., in a MAC-CE or DCI. The UE may then use the recurring resources of the configured grant for uplink transmissions, e.g., until the UE receives signaling from the network that the configured grant is deactivated. In some aspects, the UE may receive RRC signaling configuring multiple configured grants for the UE, and the UE may then receive a MAC-CE that activates one or more of the configured grants from the RRC signaling. The configured grant provides the UE with an allocation of resources that the UE can use for uplink transmissions without individual grants, e.g., in DCI, for individual uplink transmissions. Similarly, SPS scheduling may allocate periodic or semi-persistent resources for the UE to receive downlink communication. The configured grant can reduce the overhead for signaling grants to the UE and can reduce latency for the UE to transmit uplink transmissions. In FIG. 8, a UE's CG (e.g., UE1 CG 802, 804) has a larger periodicity than its SPS (e.g., UE1 SPS 812, 814, 816, 818). Hence, some occasions of the UE's SPS can be paired with another UE for SBFD operation by the network, whereas other SPS occasions may overlap in time with the CG such that the UE uses SBFD operation to transmit an uplink transmission in the CG occasion and receive a downlink transmission in the SPS occasion. For example, UE1 SPS 814 may be paired with UE2 CG 822, and UE1 SPS 818 may be paired with UE2 CG 824 for network SBFD operation, whereas the UE 1 SPS 812 and UE1 CG 802 overlap. Thus, the UE1 may switch between SBFD operation (e.g., for 812 and 802) and half-duplex operation (e.g., for 814 or 818).

Such dynamic switching may involve different operation parameters for UE SBFD and UE HD modes. These different operation parameters for the different modes may include different DL modulation and coding scheme (MCS), different UL MCS, the DL beam for the UE, different number of layers for communicating with the network, different precoding matrix indicators (PMI), different UL beams for the UE, different UL power control (PC) parameters, and different UL timing advances (TA). Additionally, if an SBFD UE has dominant traffic in one direction, the network may pair resources for the UE with another UE for network SBFD operation.

In scenarios where another UE has urgent UL traffic to transmit, the network may pair that UE with an SBFD UE for the network SBFD operation to accommodate the urgent traffic or to ensure fairness of scheduling. In this case, with dynamic grant (DG) traffic, the scheduling downlink control information (DCI) may indicate whether the UE is to operate in HD or FD mode, so that the UE may apply the appropriate preconfigured parameters. In some examples, if the mode (e.g., HD or FD mode) is not indicated, the UE may default to using the configuration for the FD mode (e.g., FD antenna panel configuration and parameters).

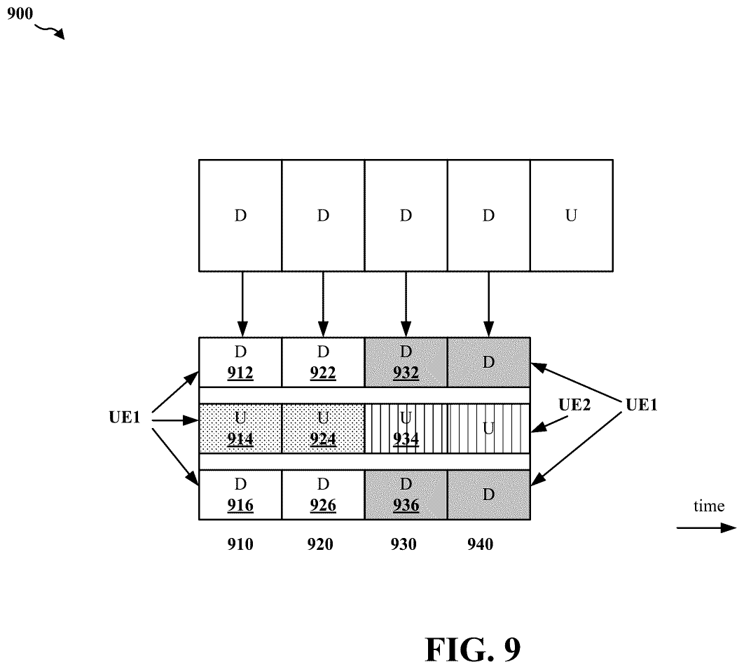

In some aspects, a UE may operate in the SBFD mode for some SBFD symbols or slots, and operate in HD mode (with the network operating in the SBFD mode) in some other SBFD symbols or slots. FIG. 9 is a diagram 900 illustrating UE operating in SBFD mode and HD mode at different symbols in accordance with various aspects of the present disclosure. In FIG. 9, a UE (UE1) may operate at the UE SBFD mode at symbols 910 and 920. For example, at symbol 910, the UE may simultaneously transmit at the UL subband (subband 914) and receive at the DL subband (subbands 912, 916). On the other hand, the UE (UE1) may operate in HD mode in symbols 930 and 940. For example, in symbol 930, the UE may receive at the DL subband (subbands 932, 936) and may not transmit (the network may allocate UL subband 934 to another UE (UE2) for UL transmission). In these scenarios, a semi-static time and DL/UL subband network SBFD configuration for an SBFD symbol may not be enough to distinguish between two different UE modes (i.e., between UE HD mode with network SBFD mode, and UE SBFD mode with network SBFD mode). Hence, the network may further indicate to the UE whether the UE is to operate in the UE HD mode (with network SBFD mode) or the UE SBFD mode (with network SBFD mode).

The further network indication may be beneficial because the UE may have different antenna configurations for the two modes. For example, the UE might utilize the full antenna array when operating in UE HD mode, whereas in UE SBFD mode, the UE may split the same antenna array into two separate arrays or panels. Additionally, in the UE SBFD mode, the network may configure the UE with two transmission configuration indicator (TCI) states to accommodate paired DL and UL transmissions, which may differ from the TCI state used in UE HD mode. Operation parameters such as UL transmission power, MCS, and DL/UL beams, may also vary between the two modes. Additionally, the radio frequency (RF) tuning might need to be readjusted, particularly if an additional filter is used in the SBFD mode to mitigate SI. In some examples, the UE SBFD mode may ask for a distinct configuration of subband, frequency pattern, or guard band, which may be different from what is used in UE HD mode.

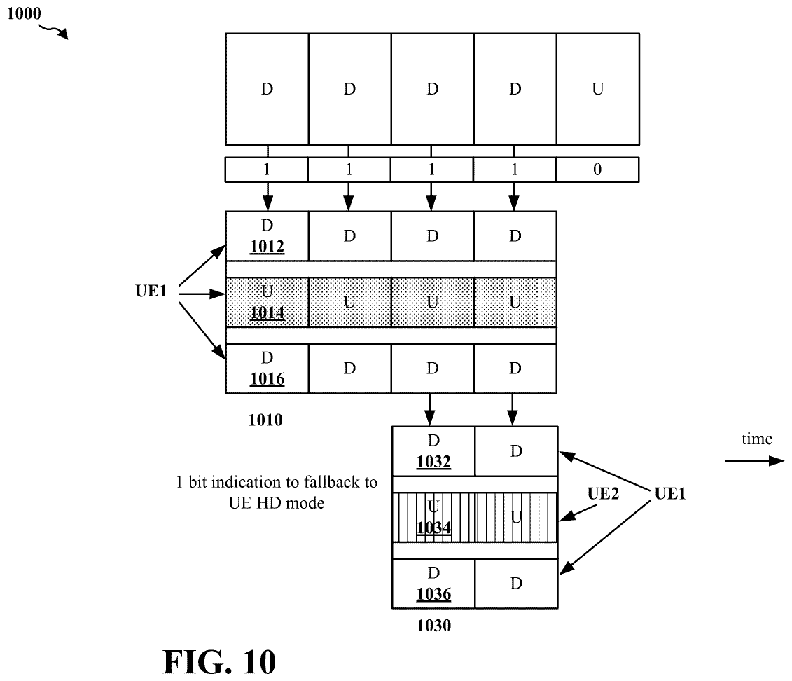

In some aspects, to indicate the two different modes (i.e., UE SBFD mode or UE HD mode with the network operating at the SBFD mode) to the UE, the network may provide a one-bit (or more bits) indication in signaling an SBFD-capable UE. One value of the indication may indicate for the UE to operate in HD mode in SBFD resources, and the other value of the indication may indicate for the UE to operate in the FD mode in the SBFD resources. This indication may be useful in situations where SI can be significant, and the UE may report the SI to the network and fallback to HD mode for more reliable communication. In some examples, the indication for mode switching could be conveyed via one or more of scheduling DCI, non-scheduling DCI, group-common (GC) DCI (e.g., GC DCI format 2_0), a radio resource control (RRC) message, or a medium access control (MAC)-control element (MAC-CE), allowing for dynamic or semi-persistent (SP) updates. FIG. 10 is a diagram 1000 illustrating an example of the indication of the UE mode in accordance with various aspects of the present disclosure. In FIG. 10, the UE (UE1) may initially operate at the UE SBFD mode. For example, the UE may simultaneously receive (via DL subband 1012 and 1016) and transmit (via UL subband 1014) at symbol 1010. If the UE receives a one-bit indication that indicates the UE to operate at UE HD mode, the UE may fall back to the UE HD mode (starting from symbol 1030, for example). For example, at symbol 930, the UE (UE1) may receive via the DL subband (e.g., DL subbands 1032, 1036) and may not transmit in symbol 1030 (the network may allocate the UL subband 1034 to another UE (UE2) for UL transmission).

In some aspects, the UE may perform instantaneous SI measurement (e.g., SI measurement triggered by the indication for the UE to operate in the full-duplex mode in the SBFD resources) and report the SI measurement result. As a comparison, the report via the channel state information (CSI) may have an interval of 40 ms, a duration that may be too long for certain applications. The report of the SI measurement result may be implemented in various ways. In some examples, a bit for SI indication may be added to the end of acknowledgment/negative acknowledgment (ACK/NACK) feedback, with “1” indicating that the SI is above a certain threshold and “0” indicating it is below the threshold, for example. In some examples, if there is configured beam management (BM) report to be sent in a certain interval (e.g., every 20 ms), the UE may add a bit at the end of the nearest configured BM report to indicate the SI. In some examples, with the configured BM report to be sent in a certain interval (e.g., every 20 ms), the UE may add a BM metric or modify an existing BM metric in the nearest configured BM report to reflect the level of SI. For example, the UE may report Layer 1 (L1) signal-to-interference-plus-noise ratio (SINR) with SI and without SI.

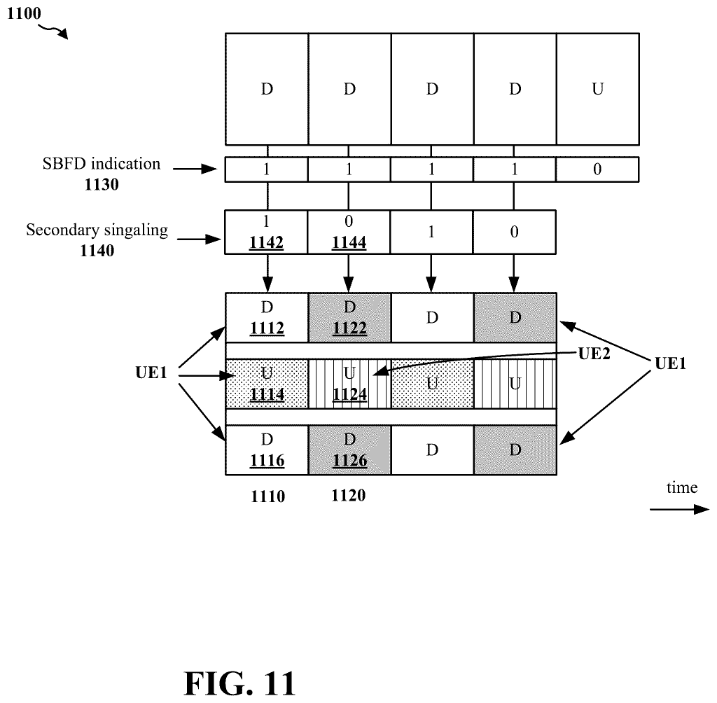

In some aspects, the indication of the two different modes (i.e., UE SBFD mode or UE HD mode with the network operating at the SBFD mode) to the UE may be based on semi-static network SBFD time indication. FIG. 11 is a diagram 1100 illustrating an example indication of UE modes in accordance with various aspects of the present disclosure. As shown in FIG. 11, the network (e.g., a base station) may indicate a secondary signaling 1140 on top of the indicated network SBFD symbols or slots (through indication 1130). This secondary signaling 1140 may indicate the UE whether it should operate in the UE HD mode or UE SBFD mode (with the network operating at the SBFD mode). An example application of this might involve the use of a predefined pattern such as SPS combined with CG.

This indication may be implemented in various ways. In one configuration, the indication may be done via a bitmap on a per-symbol or per-slot basis. In one configuration, the indication may be done by defining a window that specifies the start slot index and the length of the window, indicating a duration for the mode. In one configuration, the indication may be done via a per-slot bitmap pattern, which may indicate which slots are operating in the UE SBFD mode. For example, to indicate which slot has such a pattern, it may be assumed that all Downlink (D) or Flexible (F) slots follow the same UE SBFD pattern, or the network (e.g., a base station) may configure different patterns for different slots. To reduce the overhead, the network (e.g., a base station) may configure a table of various patterns and indicate the index of the relevant pattern for each slot. These indications could be communicated to the UE through different channels, such as an RRC message, a MAC-CE, or DCI. In the example of FIG. 11, the index of “1” in 1142 in the secondary signaling 1140 may indicate the UE to work in SBFD mode for symbol 1110, meaning the UE may simultaneously transmit (e.g., at UL subband 1114) and receive (e.g., at DL subbands 1112 and 1116) in symbol 1110. On the other hand, the index of “0” in 1144 in the secondary signaling 1140 may indicate the UE to work in HD mode for symbol 1120, meaning the UE may receive (e.g., at DL subbands 1122 and 1126) but may not transmit in symbol 1120 (the network may allocate the UL subband 1124 to another UE (UE2) for UL transmission).

In some aspects, in addition to or alternative to instantaneous SI measurement and reporting, the UE may perform periodic beam management (BM) that considers the SI at the UE. For example, the UE may report SI along with a beam management report. In some aspects, the UE may receive a configuration enabling the UE to provide for SI measurement and reporting. In some examples, for both UE FD and UE SBFD operations, a group-based beam report may be provided to report a pair of DL and UL beams to facilitate FD operations at the UE while minimizing the impact of SI on the DL beam from its own UL transmission.

In some examples, the UE may report the DL signal-to-interference-plus-noise ratio (SINR) in the BM report. The SINR may consider SI as an additional form of interference, with a new inference measurement resource (IMR) configured for SI resource and measurement. In some examples, in the BM report, the UE may report on the DL reference signal received power (RSRP) as measured with a UE UL beam (e.g., the network may transmit DL traffic and the UE may receive with the UL beam). This measurement may reflect the quality of the UL beam, which may help to establish a reliable UL link for FD operations. The selection of the DL and UL beam pair may be based on these combined measurements and reporting for DL SINR and DL RSRP as measured with the UE's UL beam.

In some aspects, for the purposes of beam selection and beam report, the UE may report, in the CSI report, two hypotheses. The first hypothesis may include a channel quality indicator (CQI) with SI included as measured interference, and the second hypothesis may include another CQI without the influence of SI.

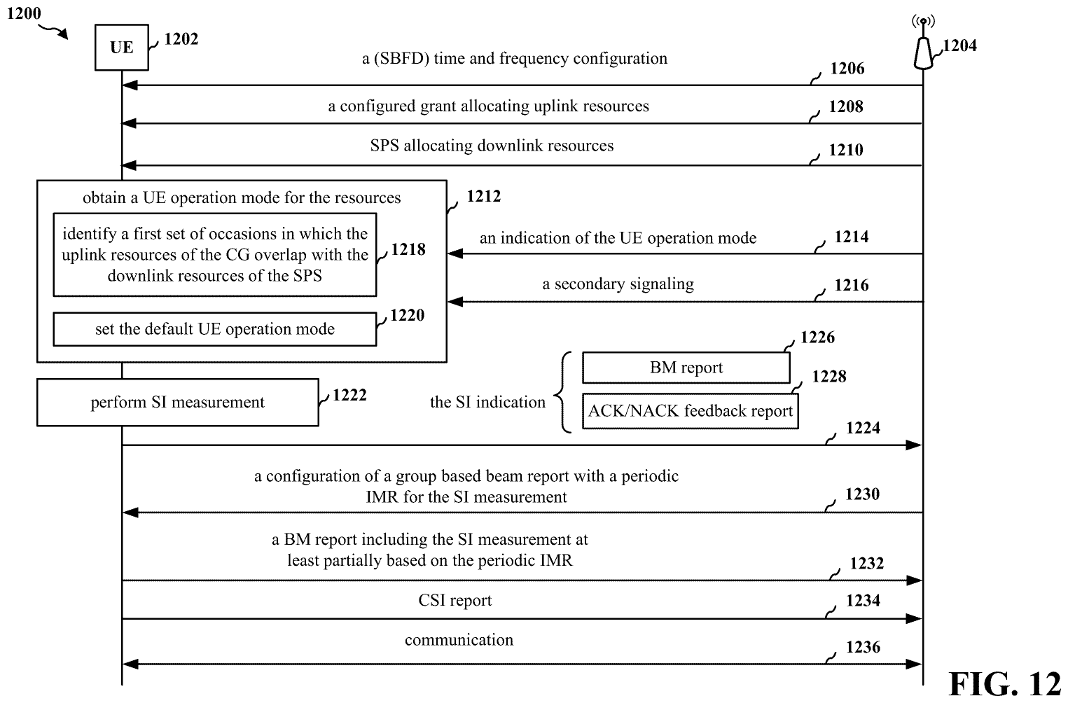

FIG. 12 is a call flow diagram 1200 illustrating a method of wireless communication in accordance with various aspects of this present disclosure. Various aspects are described in connection with a UE 1202 and a base station 1204. The aspects may be performed by the UE 1202 or the base station 1204 in aggregation and/or by one or more components of a base station 1204 (e.g., a CU 110, a DU 130, and/or an RU 140).

As shown in FIG. 12, at 1206, the UE 1202 may receive a time and frequency configuration from the base station 1204. In some examples, the time and frequency configuration may be SBFD time and frequency configuration that allocates resources for communication with the base station 1204 based on an SBFD mode. For example, referring to FIG. 9, the SBFD time and frequency configuration may allocate resources (e.g., symbols 910 and 920) for communication with the base station.

At 1208, the UE 1202 may receive a configured grant (CG) allocating uplink resources for uplink transmissions. At 1210, the UE 1202 may receive SPS allocating downlink resources for reception of downlink transmissions. For example, referring to FIG. 8, the UE may receive a CG allocating uplink resources (e.g., UE1 CG 802, 804) and SPS allocation downlink resources (e.g., UE1 SPS 812, 814, 816, 818).

At 1212, the UE 1202 may obtain a UE operation mode for the resources. The UE operation mode is one of a UE FD mode or a UE HD mode. For example, referring to FIG. 9, the UE operation mode may be UE FD mode for symbols 910 and 920, meaning the UE can transmit (e.g., at UL subbands 914, 924) and receive (e.g., at DL subbands 912, 916, 922, 926) simultaneously at these symbols. The UE operation mode may be UE HD mode at symbols 930 and 940, meaning the UE may perform one of transmit or receive, but not both at these symbols. For example, UE1 may receive (e.g., at DL subband 932 and 936) but may not transmit at symbol 930.

The UE operation mode for the resources may be obtained in various ways. In some example, at 1214, the UE 1202 may receive an indication of the UE operation mode from base station 1204. In some examples, the UE 1202 may further receive a secondary signaling (e.g., secondary signaling 1140) at 1216.

In some aspects, the UE 1202 may, at 1218, identify a first set of occasions in which the uplink resources of the configured grant overlap with the downlink resources of the SPS to obtain the UE operation mode. For example, referring to FIG. 8, for the occasions in which the uplink resources (e.g., UE1 CG 802) overlap with the downlink resources (e.g., UE1 SPS 812), the UE operation mode may be UE FD mode for these occasions.

In some aspects, the UE 1202 may, at 1220, set the default UE operation mode when the UE operation mode is not indicated, for example. In some examples, the UE 1202 may set the UE FD mode as the default UE operation mode.

At 1222, the UE 1202 may perform the SI measurement. In some examples, the UE 1202 may perform SI measurement when the UE operation mode is UE FD mode.

At 1224, the UE 1202 may transmit the SI indication, which may include the SI indication to the base station 1204. The SI indication may be transmitted via, for example, a BM report (1226) or an ACK/NACK feedback report (1228).

At 1230, the base station 1204 may transmit a configuration of a group based beam report with a periodic IMR for the SI measurement.

At 1232, the UE 1202 may transmit to the base station 1204 a beam management (BM) report including the SI measurement at least partially based on the periodic IMR.

At 1234, the UE 1202 may transmit to the base station 1204 a CSI report. In some examples, the CSI report may include two hypotheses. The first hypothesis may be associated with the first CQI including an SI as an interference source, and the second hypothesis may be associated with the second CQI not including the SI as the interference source.

At 1236, the UE 1202 may communicate with the base station 1204 in the resources allocated for the UE based on the UE operation mode.

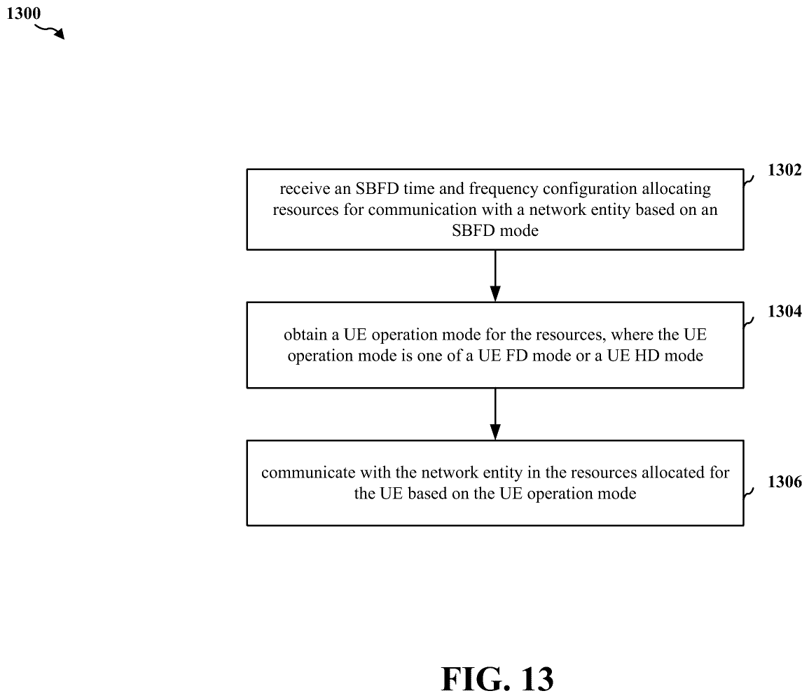

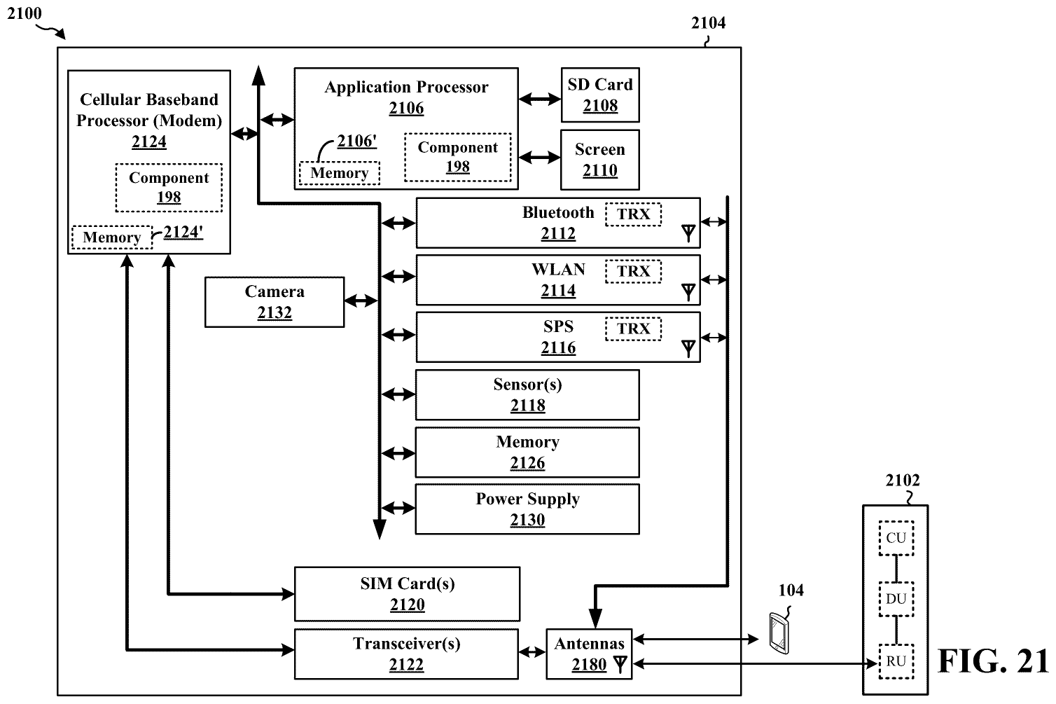

FIG. 13 is a flowchart 1300 illustrating methods of wireless communication at a UE in accordance with various aspects of the present disclosure. The method may be performed by a UE. The UE may be the UE 104, 350, 1202, or the apparatus 2104 in the hardware implementation of FIG. 21. By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 13, at 1302, the UE may receive an SBFD time and frequency configuration allocating resources for communication with a network entity based on an SBFD mode. The network entity may be a base station, or a component of a base station, in the access network of FIG. 1 or a core network component (e.g., base station 102, 310, 1204; or the network entity 2102 in the hardware implementation of FIG. 21). FIGS. 8, 9, 10, 11, and 12 illustrate various aspects of the steps in connection with flowchart 1300. For example, referring to FIG. 12, the UE 1202 may receive, at 1206, an SBFD time and frequency configuration allocating resources for communication with a network entity (base station 1204) based on an SBFD mode. In some aspects, 1302 may be performed by the operation mode component 198.

At 1304, the UE may obtain a UE operation mode for the resources. The UE operation mode may be one of a UE FD mode or a UE HD mode. For example, referring to FIG. 12, the UE 1202 may, at 1212, obtain a UE operation mode for the resources. The UE operation mode may be one of a UE FD mode or a UE HD mode. Referring to FIG. 9, the UE operation mode may be UE FD mode for symbols 910 and 920, meaning the UE can transmit (e.g., at UL subbands 914, 924) and receive (e.g., at DL subbands 912, 916, 922, 926) simultaneously at these symbols. The UE operation mode may be UE HD mode at symbols 930 and 940, meaning the UE may perform one of transmit or receive, but not both at these symbols. For example, UE1 may receive (e.g., at DL subband 932 and 936) but may not transmit at symbol 930. In some aspects, 1304 may be performed by the operation mode component 198.

At 1306, the UE may communicate with the network entity in the resources allocated for the UE based on the UE operation mode. For example, referring to FIG. 12, the UE 1202 may, at 1236, communicate with the network entity (base station 1204) in the resources (e.g., symbols 910, 920, 930, 940) allocated for the UE based on the UE operation mode. In some aspects, 1306 may be performed by the operation mode component 198.

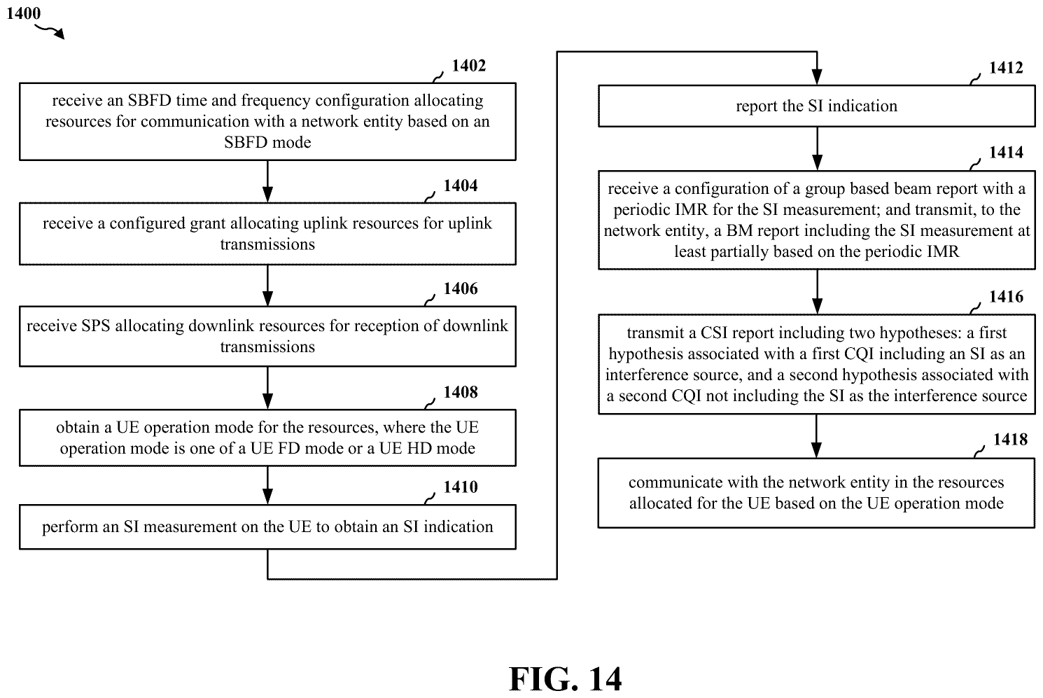

FIG. 14 is a flowchart 1400 illustrating methods of wireless communication at a UE in accordance with various aspects of the present disclosure. The method may be performed by a UE. The UE may be the UE 104, 350, 1202, or the apparatus 2104 in the hardware implementation of FIG. 21. By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 14, at 1402, the UE may receive an SBFD time and frequency configuration allocating resources for communication with a network entity based on an SBFD mode. The network entity may be a base station, or a component of a base station, in the access network of FIG. 1 or a core network component (e.g., base station 102, 310, 1204; or the network entity 2102 in the hardware implementation of FIG. 21). FIGS. 8, 9, 10, 11, and 12 illustrate various aspects of the steps in connection with flowchart 1400. For example, referring to FIG. 12, the UE 1202 may receive, at 1206, an SBFD time and frequency configuration allocating resources for communication with a network entity (base station 1204) based on an SBFD mode. In some aspects, 1402 may be performed by the operation mode component 198.

At 1408, the UE may obtain a UE operation mode for the resources. The UE operation mode may be one of a UE FD mode or a UE HD mode. For example, referring to FIG. 12, the UE 1202 may, at 1212, obtain a UE operation mode for the resources. The UE operation mode may be one of a UE FD mode or a UE HD mode. Referring to FIG. 9, the UE operation mode may be UE FD mode for symbols 910 and 920, meaning the UE can transmit (e.g., at UL subbands 914, 924) and receive (e.g., at DL subbands 912, 916, 922, 926) simultaneously at these symbols. The UE operation mode may be UE HD mode at symbols 930 and 940, meaning the UE may perform one of transmit or receive, but not both at these symbols. For example, UE1 may receive (e.g., at DL subband 932 and 936) but may not transmit at symbol 930. In some aspects, 1408 may be performed by the operation mode component 198.

At 1418, the UE may communicate with the network entity in the resources allocated for the UE based on the UE operation mode. For example, referring to FIG. 12, the UE 1202 may, at 1236, communicate with the network entity (base station 1204) in the resources (e.g., symbols 910, 920, 930, 940) allocated for the UE based on the UE operation mode. In some aspects, 1418 may be performed by the operation mode component 198.

In some aspects, the UE may, at 1404, receive a configured grant allocating uplink resources for uplink transmissions, and, at 1406, receive SPS allocating downlink resources for reception of downlink transmissions. To obtain the UE operation mode for the resources, the UE may identify a first set of occasions in which the uplink resources of the configured grant overlap with the downlink resources of the SPS. To communicate with the network entity, the UE may communicate with the network entity based on a first set of one or more operation parameters associated with a first UE operation mode in the first set of occasions and a second set of one or more operation parameters associated with a second UE operation mode in the second set of one or more occasions. For example, referring to FIG. 12, the UE 1202 may, at 1208, receive a configured grant allocating uplink resources for uplink transmissions, and, at 1210, receive SPS allocating downlink resources for reception of downlink transmissions. To obtain the UE operation mode (at 1212) for the resources, the UE 1202 may, at 1218, identify a first set of occasions in which the uplink resources of the configured grant overlap with the downlink resources of the SPS. For example, referring to FIG. 8, for the occasions in which the uplink resources (e.g., UE1 CG 802) overlap with the downlink resources (e.g., UE1 SPS 812), the UE operation mode may be UE FD mode for these occasions. The UE 1202 may communicate, at 1236, with the network entity (base station 1204) based on a first set of one or more operation parameters associated with a first UE operation mode in the first set of occasions (e.g., the occasions with UE1 SPS 812 and UE1 CG 802) and a second set of one or more operation parameters associated with a second UE operation mode in the second set of one or more occasions (e.g., the occasion with UE1 SPS 814). In some aspects, 1404 and 1406 may be performed by the operation mode component 198.

In some aspects, the one or more operation parameters associated with the UE operation mode may include one or more of: a DL MCS, a UL MCS, a DL beam for the UE, a number of layers for communicating with the network entity, a PMI, a UL beam for the UE, UL PC parameters for the UE, or UL TA. For example, referring to FIG. 12, the one or more operation parameters associated with the UE operation mode (obtained at 1212) may include one or more of: a DL MCS, a UL MCS, a DL beam for the UE, a number of layers for communicating with the network entity (base station 1204), a PMI, a UL beam for the UE 1202, UL PC parameters for the UE 1202, or UL TA.

In some aspects, to obtain the UE operation mode (at 1408), the UE may receive an indication of the UE operation mode for the resources in the SBFD time and frequency configuration. For example, referring to FIGS. 11 and 12, the UE 1202 may receive an indication (e.g., SBFD indication 1130) of the UE operation mode for the resources in the SBFD time and frequency configuration (at 1206).

In some aspects, to obtain the UE operation mode (at 1408), the UE may set a default operation mode of the UE operation mode as the UE FD mode in response to the SBFD time and frequency configuration not indicating the UE operation mode. For example, referring to FIG. 12, the UE 1202 may, at 1220, set a default operation mode of the UE operation mode as the UE FD mode in response to the SBFD time and frequency configuration not indicating the UE operation mode.

In some aspects, the indication of the UE operation mode may include a one-bit indicator, and the one-bit indicator may be included in one of: scheduling DCI, non-scheduling DCI, GC DCI, an RRC message, or a MAC-CE. For example, referring to FIG. 12, the indication of the UE operation mode (at 1214 or 1206) may include a one-bit indicator, and the one-bit indicator may be included in one of: scheduling DCI, non-scheduling DCI, GC DCI, an RRC message, or a MAC-CE.

In some aspects, to communicate with the network entity (at 1418), the UE may apply a set of one or more operation parameters associated with the UE operation mode, and communicate with the network entity based on the set of one or more operation parameters. The one or more operation parameters may include one or more of: a DL MCS, a UL MCS, a DL beam for the UE, the number of layers for communicating with the network entity, a PMI, a UL beam for the UE, UL PC parameters for the UE, or UL TA. For example, referring to FIG. 12, to communicate with the network entity (at 1236), the UE 1202 may apply a set of one or more operation parameters associated with the UE operation mode (obtained at 1212), and communicate (at 1236) with the network entity (base station 1204) based on the set of one or more operation parameters. The one or more operation parameters may include one or more of: a DL MCS, a UL MCS, a DL beam for the UE 1202, the number of layers for communicating with the network entity (base station 1204), a PMI, a UL beam for the UE 1202, UL PC parameters for the UE 1202, or UL TA.

In some aspects, the UE may, at 1410, perform, in response to a reception of the indication of the UE operation mode in the UE FD mode, an SI measurement on the UE to obtain an SI indication, and, at 1412, report the SI indication to the network entity. For example, referring to FIG. 12, the UE 1202 may, at 1222, perform, in response to a reception of the indication of the UE operation mode in the UE FD mode, an SI measurement on the UE 1202 to obtain an SI indication, and, at 1224, report the SI indication to the network entity (base station 1204). In some aspects, 1410 and 1412 may be performed by the operation mode component 198.

In some aspects, the SI indication may be a one-bit indication indicating a comparison of the SI measurement with an SI threshold and may be included in at least one of: an ACK/NACK feedback report, or a BM report. The SI indication may be included in a bit at the end of the BM report, a new BM metric, or an existing BM metric in the BM report. For example, referring to FIG. 12, the SI indication (at 1224) may be a one-bit indication indicating a comparison of the SI measurement with an SI threshold and may be included in an ACK/NACK feedback report (1228) or a BM report (1226).

In some aspects, to report the SI indication (at 1412), the UE may report the SI indication in the nearest BM report or the nearest ACK/NACK feedback report. For example, referring to FIG. 12, the UE 1202 may report the SI indication (at 1224) in the nearest BM report (1226) or the nearest ACK/NACK feedback report (1228).

In some aspects, at 1414, the UE may receive a configuration of a group based beam report with a periodic IMR for the SI measurement; and transmit, to the network entity, a BM report including the SI measurement at least partially based on the periodic IMR. For example, referring to FIG. 12, the UE 1202 may receive, at 1230, a configuration of a group based beam report with a periodic IMR for the SI measurement; and, at 1232, transmit, to the network entity (base station 1204), a BM report including the SI measurement at least partially based on the periodic IMR. In some aspects, 1414 may be performed by the operation mode component 198.

In some aspects, the BM report may further include: in response to the indication of the UE operation mode indicating the UE FD mode, a selected DL beam and a selected UL beam for the UE FD mode. For example, referring to FIG. 12, the BM report (at 1232) may further include: in response to the indication of the UE operation mode indicating the UE FD mode, a selected DL beam and a selected UL beam for the UE FD mode.

In some aspects, the BM report may further include one or more of: in response to the indication of the UE operation mode indicating the UE FD mode, a DL SINR of the UE, where the SINR includes the SI as an interference, and a DL RSRP measured with a UE UL beam. For example, referring to FIG. 12, the BM report (at 1232) may further include one or more of: in response to the indication of the UE operation mode indicating the UE FD mode, a DL SINR of the UE, where the SINR includes the SI as an interference, and a DL RSRP measured with a UE UL beam.

In some aspects, the selected DL beam and the selected UL beam may be based on the DL SINR and the DL RSRP measured with the UE UL beam.

In some aspects, at 1416, the UE may transmit, to the network entity, a CSI report. The CSI report may include two hypotheses. The first hypothesis may be associated with the first CQI including an SI as an interference source, and the second hypothesis may be associated with the second CQI not including the SI as the interference source. For example, referring to FIG. 12, the UE 1202 may transmit, at 1234, to the network entity (base station 1204), a CSI report. The CSI report may include two hypotheses. The first hypothesis may be associated with the first CQI including an SI as an interference source, and the second hypothesis may be associated with the second CQI not including the SI as the interference source. In some aspects, 1416 may be performed by the operation mode component 198.

In some aspects, the SBFD time and frequency configuration may include a semi-static network SBFD time and frequency indication indicating at least a part of the resources as FD resources. To obtain the UE operation mode (at 1408), the UE may receive, from the network entity, a secondary signaling over the FD resources; and obtain, based on the secondary signaling, a UE mode indicator indicating the UE operation mode corresponding to the FD resources or HD resources. For example, referring to FIGS. 11 and 12, the SBFD time and frequency configuration (at 1206) may include a semi-static network SBFD time and frequency indication (SBFD indication 1130) indicating at least a part of the resources (e.g., symbol 1110) as FD resources. To obtain the UE operation mode (at 1212), the UE 1202 may receive, at 1216, from the network entity (base station 1204), a secondary signaling (secondary signaling 1140) over the FD resources (e.g., symbol 1110); and obtain, based on the secondary signaling, a UE mode indicator indicating the UE operation mode corresponding to the FD resources or HD resources.

In some aspects, the UE mode indicator may include one of: a bitmap indication per symbol or per slot, a start index indicating a start slot index and a length of a window where the UE operation mode is applicable, or a pattern index identifying one bitmap pattern from a plurality of bitmap patterns in a pre-configured table for each slot.

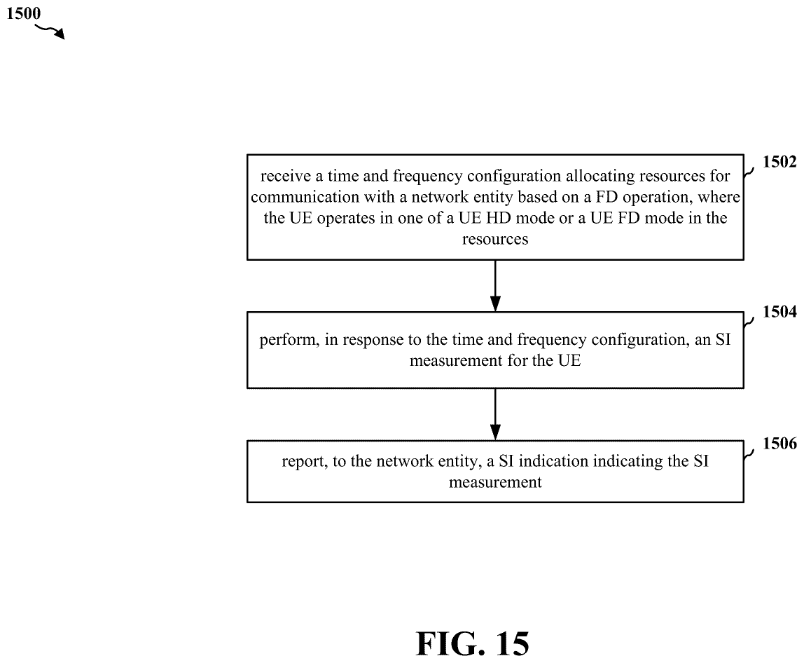

FIG. 15 is a flowchart 1500 illustrating methods of wireless communication at a UE in accordance with various aspects of the present disclosure. The method may be performed by a UE. The UE may be the UE 104, 350, 1202, or the apparatus 2104 in the hardware implementation of FIG. 21. By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 15, at 1502, the UE may receive a time and frequency configuration allocating resources for communication with a network entity based on an FD operation. The UE operates in one of a UE HD mode or a UE FD mode in the resources. The network entity may be a base station, or a component of a base station, in the access network of FIG. 1 or a core network component (e.g., base station 102, 310, 1204; or the network entity 2102 in the hardware implementation of FIG. 21). FIGS. 8, 9, 10, 11, and 12 illustrate various aspects of the steps in connection with flowchart 1500. For example, referring to FIG. 12, the UE 1202 may receive, at 1206, a time and frequency configuration allocating resources for communication with a network entity (base station 1204) based on an FD mode. In some aspects, 1502 may be performed by the operation mode component 198.

At 1504, the UE may perform, in response to the time and frequency configuration, an SI measurement for the UE. For example, referring to FIG. 12, the UE 1202 may perform, at 1222, in response to the time and frequency configuration, an SI measurement for the UE 1202. In some aspects, 1504 may be performed by the operation mode component 198.

At 1506, the UE may report, to the network entity, an SI indication indicating the SI measurement. For example, referring to FIG. 12, the UE 1202 may report, at 1224, to the network entity (base station 1204), an SI indication indicating the SI measurement. In some aspects, 1506 may be performed by the operation mode component 198.

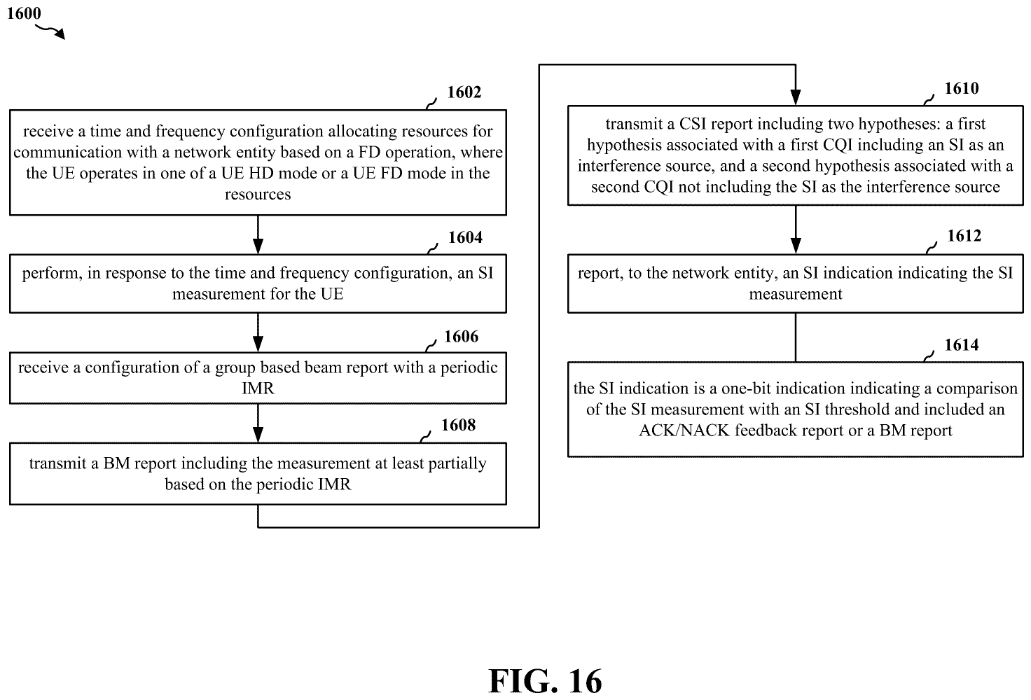

FIG. 16 is a flowchart 1600 illustrating methods of wireless communication at a UE in accordance with various aspects of the present disclosure. The method may be performed by a UE. The UE may be the UE 104, 350, 1202, or the apparatus 2104 in the hardware implementation of FIG. 21. By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 16, at 1602, the UE may receive a time and frequency configuration allocating resources for communication with a network entity based on an FD operation. The UE operates in one of a UE HD mode or a UE FD mode in the resources. The network entity may be a base station, or a component of a base station, in the access network of FIG. 1 or a core network component (e.g., base station 102, 310, 1204; or the network entity 2102 in the hardware implementation of FIG. 21). FIGS. 8, 9, 10, 11, and 12 illustrate various aspects of the steps in connection with flowchart 1600. For example, referring to FIG. 12, the UE 1202 may receive, at 1206, a time and frequency configuration allocating resources for communication with a network entity (base station 1204) based on an FD mode. In some aspects, 1602 may be performed by the operation mode component 198.

At 1604, the UE may perform, in response to the time and frequency configuration, an SI measurement for the UE. For example, referring to FIG. 12, the UE 1202 may perform, at 1222, in response to the time and frequency configuration, an SI measurement for the UE 1202. In some aspects, 1604 may be performed by the operation mode component 198.

At 1612, the UE may report, to the network entity, an SI indication indicating the SI measurement. For example, referring to FIG. 12, the UE 1202 may report, at 1224, to the network entity (base station 1204), an SI indication indicating the SI measurement. In some aspects, 1612 may be performed by the operation mode component 198.

In some aspects, at 1614, the SI indication may be a one-bit indication indicating a comparison of the SI measurement with an SI threshold and may be included in at least one of: an ACK/NACK feedback report, or a BM report. The SI indication may be included in a bit at the end of the BM report, a new BM metric, or an existing BM metric in the BM report. For example, referring to FIG. 12, the SI indication (at 1224) may be a one-bit indication indicating a comparison of the SI measurement with an SI threshold and may be included in an ACK/NACK feedback report (1228) or a BM report (1226)

In some aspects, to report the SI indication (at 1612), the UE may report the SI indication in the nearest BM report or the nearest ACK/NACK feedback report. For example, referring to FIG. 12, the UE 1202 may report the SI indication (at 1224) in the nearest BM report (1226) or the nearest ACK/NACK feedback report (1228).

In some aspects, the UE may, at 1606, receive a configuration of a group based beam report with a periodic IMR, and, at 1608, transmit, to the network entity, a BM report including the measurement at least partially based on the periodic IMR. For example, referring to FIG. 12, the UE 1202 may, at 1230, receive a configuration of a group based beam report with a periodic IMR, and, at 1232, transmit, to the network entity (base station 1204), a BM report including the measurement at least partially based on the periodic IMR. In some aspects, 1606 and 1608 may be performed by the operation mode component 198.

In some aspects, the BM report may further include: in response to a UE mode indicator indicating the UE FD mode, a selected DL beam and a selected UL beam for the UE FD mode. For example, referring to FIG. 12, the BM report (at 1232) may further include: in response to the UE mode indicator indicating the UE FD mode, a selected DL beam and a selected UL beam for the UE FD mode.

In some aspects, the BM report may further include one or more of: in response to the UE mode indicator indicating the UE FD mode, a DL SINR of the UE, where the SINR includes the SI as an interference, and a DL RSRP measured with a UE UL beam. For example, referring to FIG. 12, the BM report (at 1232) may further include one or more of: in response to the UE mode indicator indicating the UE FD mode, a DL SINR of the UE. The SINR includes the SI as an interference, and a DL RSRP measured with a UE UL beam.

In some aspects, the selected DL beam and the selected UL beam may be based on the DL SINR and the DL RSRP measured with the UE UL beam.

In some aspects, at 1610, the UE may transmit, to the network entity, a CSI report. The CSI report may include two hypotheses. The first hypothesis may be associated with the first CQI including an SI as an interference source, and the second hypothesis may be associated with the second CQI not including the SI as the interference source. For example, referring to FIG. 12, the UE 1202 may, at 1234, transmit, to the network entity (base station 1204), a CSI report. The CSI report may include two hypotheses. The first hypothesis may be associated with the first CQI including an SI as an interference source, and the second hypothesis may be associated with the second CQI not including the SI as the interference source.

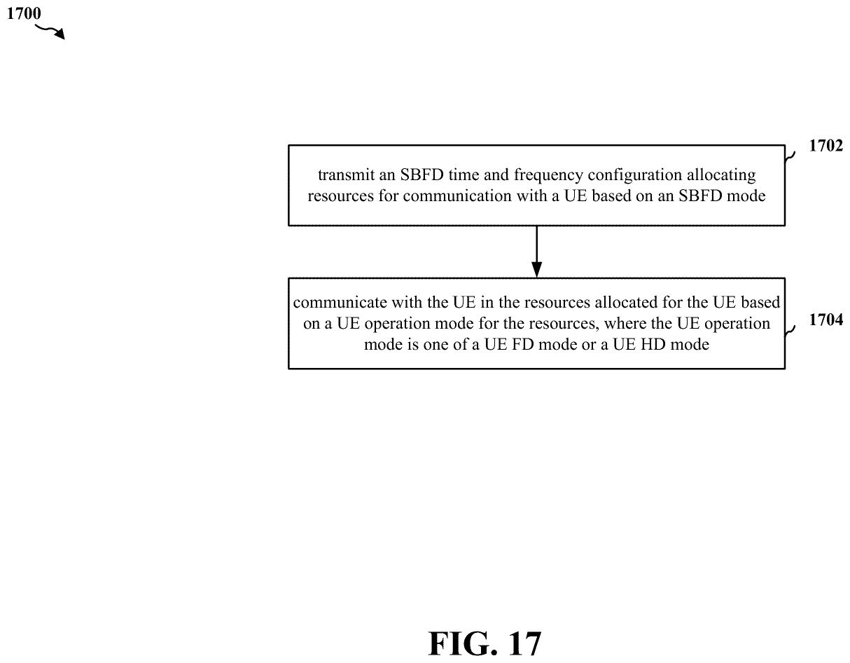

FIG. 17 is a flowchart 1700 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 2102 in the hardware implementation of FIG. 21). By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 17, at 1702, the network entity may transmit an SBFD time and frequency configuration allocating resources for communication with a UE based on an SBFD mode. The UE may be the UE 104, 350, 1202, or the apparatus 2104 in the hardware implementation of FIG. 21. FIGS. 8, 9, 10, 11, and 12 illustrate various aspects of the steps in connection with flowchart 1700. For example, referring to FIG. 12, the network entity (base station 1204) may, at 1206, transmit an SBFD time and frequency configuration allocating resources for communication with a UE 1202 based on an SBFD mode. In some aspects, 1702 may be performed by the operation mode component 199.

At 1704, the network entity may communicate with the UE in the resources allocated for the UE based on a UE operation mode for the resources, where the UE operation mode is one of a UE FD mode or a UE HD mode. For example, referring to FIG. 12, the network entity (base station 1204) may, at 1236, communicate with the UE 1202 in the resources allocated for the UE 1202 based on a UE operation mode for the resources. The UE operation mode is one of a UE FD mode or a UE HD mode. Referring to FIG. 9, the UE operation mode may be UE FD mode for symbols 910 and 920, meaning the UE can transmit (e.g., at UL subbands 914, 924) and receive (e.g., at DL subbands 912, 916, 922, 926) simultaneously at these symbols. The UE operation mode may be UE HD mode at symbols 930 and 940, meaning the UE may perform one of transmit or receive, but not both at these symbols. For example, UE1 may receive (e.g., at DL subband 932 and 936) but may not transmit at symbol 930. In some aspects, 1704 may be performed by the operation mode component 199.

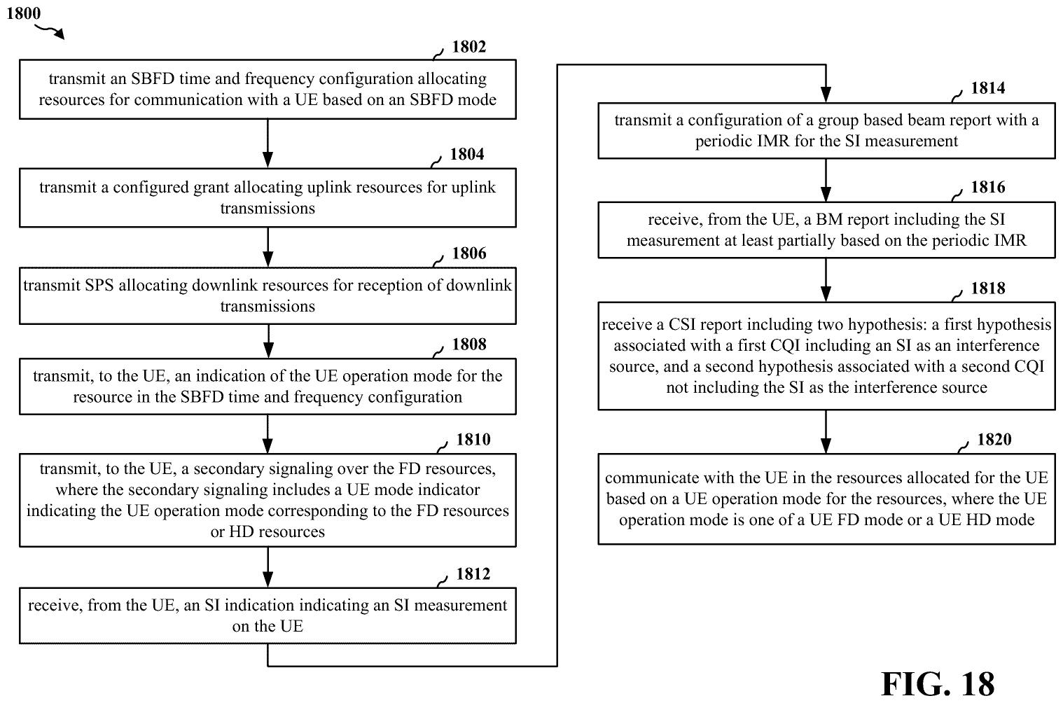

FIG. 18 is a flowchart 1800 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 2102 in the hardware implementation of FIG. 21). By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 18, at 1802, the network entity may transmit an SBFD time and frequency configuration allocating resources for communication with a UE based on an SBFD mode. The UE may be the UE 104, 350, 1202, or the apparatus 2104 in the hardware implementation of FIG. 21. FIGS. 8, 9, 10, 11, and 12 illustrate various aspects of the steps in connection with flowchart 1800. For example, referring to FIG. 12, the network entity (base station 1204) may, at 1206, transmit an SBFD time and frequency configuration allocating resources for communication with a UE 1202 based on an SBFD mode. In some aspects, 1802 may be performed by the operation mode component 199.

At 1820, the network entity may communicate with the UE in the resources allocated for the UE based on a UE operation mode for the resources. The UE operation mode is one of a UE FD mode or a UE HD mode. For example, referring to FIG. 12, the network entity (base station 1204) may, at 1236, communicate with the UE 1202 in the resources allocated for the UE 1202 based on a UE operation mode for the resources. The UE operation mode is one of a UE FD mode or a UE HD mode. Referring to FIG. 9, the UE operation mode may be UE FD mode for symbols 910 and 920, meaning the UE can transmit (e.g., at UL subbands 914, 924) and receive (e.g., at DL subbands 912, 916, 922, 926) simultaneously at these symbols. The UE operation mode may be UE HD mode at symbols 930 and 940, meaning the UE may perform one of transmit or receive, but not both at these symbols. For example, UE1 may receive (e.g., at DL subband 932 and 936) but may not transmit at symbol 930. In some aspects, 1820 may be performed by the operation mode component 199.

In some aspects, the network entity may, at 1804, transmit a configured grant allocating uplink resources for uplink transmissions, and, at 1806, transmit SPS allocating downlink resources for reception of downlink transmissions. The UE operation mode for the resources may be based on a first set of occasions in which the uplink resources of the configured grant overlaps with the downlink resources of the SPS. To communicate with the UE, the network entity may communicate with the UE based on a first set of one or more operation parameters associated with a first UE operation mode in the first set of occasions and a second set of one or more operation parameters associated with a second UE operation mode in the second set of one or more occasions For example, referring to FIG. 12, the network entity (base station 1204) may, at 1208, transmit a configured grant allocating uplink resources for uplink transmissions, and, at 1210, transmit SPS allocating downlink resources for reception of downlink transmissions. Referring to FIG. 8, for the occasions in which the uplink resources (e.g., UE1 CG 802) overlap with the downlink resources (e.g., UE1 SPS 812), the UE operation mode may be UE FD mode for these occasions. The network entity (base station 1204) may communicate, at 1236, with the UE 1202 based on a first set of one or more operation parameters associated with a first UE operation mode in the first set of occasions (e.g., the occasions with UE1 SPS 812 and UE1 CG 802) and a second set of one or more operation parameters associated with a second UE operation mode in the second set of one or more occasions (e.g., the occasion with UE1 SPS 814). In some aspects, 1804 and 1806 may be performed by the operation mode component 199.

In some aspects, the one or more operation parameters associated with the UE operation mode may include one or more of: a DL MCS, a UL MCS, a DL beam for the UE, the number of layers for communicating with the network entity, a PMI, a UL beam for the UE, UL PC parameters for the UE, or UL TA. For example, referring to FIG. 12, the one or more operation parameters associated with the UE operation mode (obtained at 1212) may include one or more of: a DL MCS, a UL MCS, a DL beam for the UE 1202, the number of layers for communicating with the network entity (base station 1204), a PMI, a UL beam for the UE 1202, UL PC parameters for the UE 1202, or UL TA.

In some aspects, at 1808, the network entity may transmit, to the UE, an indication of the UE operation mode for the resource in the SBFD time and frequency configuration. For example, referring to FIGS. 11 and 12, the network entity (base station 1204) may transmit, to the UE 1202, an indication (e.g., SBFD indication 1130) of the UE operation mode for the resource in the SBFD time and frequency configuration (at 1206). In some aspects, 1808 may be performed by the operation mode component 199.

In some aspects, the indication of the UE operation mode may include a one-bit indicator, and the one-bit indicator may be included in one of: scheduling DCI, non-scheduling DCI, GC DCI, an RRC message, or a MAC-CE. For example, referring to FIG. 12, the indication of the UE operation mode (at 1214 or 1206) may include a one-bit indicator, and the one-bit indicator may be included in one of: scheduling DCI, non-scheduling DCI, GC DCI, an RRC message, or a MAC-CE.

In some aspects, at 1812, the network entity may receive, from the UE, an SI indication indicating an SI measurement on the UE. For example, referring to FIG. 12, the network entity (base station 1204) may receive, at 1224, from the UE 1202, an SI indication indicating an SI measurement on the UE 1202. In some aspects, 1812 may be performed by the operation mode component 199.

In some aspects, the SI indication may be a one-bit indication indicating a comparison of the SI measurement with an SI threshold and may be included in at least one of: an ACK/NACK feedback report, or a BM report. The SI indication may be included in a bit at the end of the BM report, a new BM metric, or an existing BM metric in the BM report. For example, referring to FIG. 12, the SI indication (at 1224) may be a one-bit indication indicating a comparison of the SI measurement with an SI threshold and may be included in an ACK/NACK feedback report (1228) or a BM report (1226).

In some aspects, the SI indication may be included in the nearest BM report or the nearest ACK/NACK feedback report. For example, referring to FIG. 12, the SI indication may be included in the nearest BM report (1226) or the nearest ACK/NACK feedback report (1228).

In some aspects, the network entity may, at 1814, transmit a configuration of a group based beam report with a periodic IMR for the SI measurement, and at 1816, receive, from the UE, a BM report including the SI measurement at least partially based on the periodic IMR. For example, referring to FIG. 12, the network entity (base station 1204) may, at 1230, transmit a configuration of a group based beam report with a periodic IMR for the SI measurement, and at 1232, receive, from the UE 1202, a BM report including the SI measurement at least partially based on the periodic IMR. In some aspects, 1814 and 1816 may be performed by the operation mode component 199.

In some aspects, the BM report may further include: in response to the indication of the UE operation mode indicating the UE FD mode, a selected DL beam and a selected UL beam for the UE FD mode. For example, referring to FIG. 12, the BM report (at 1232) may further include: in response to the indication of the UE operation mode indicating the UE FD mode, a selected DL beam and a selected UL beam for the UE FD mode.

In some aspects, the BM report may further include one or more of: in response to the indication of the UE operation mode indicating the UE FD mode, a DL SINR of the UE, where the SINR includes the SI as an interference, and a DL RSRP measured with a UE UL beam. For example, referring to FIG. 12, the BM report (at 1232) may further include one or more of: in response to the indication of the UE operation mode indicating the UE FD mode, a DL SINR of the UE, where the SINR includes the SI as an interference, and a DL RSRP measured with a UE UL beam.

In some aspects, the selected DL beam and the selected UL beam may be based on the DL SINR and the DL RSRP measured with the UE UL beam.

In some aspects, at 1818, the network entity may receive, from the UE, a CSI report. The CSI report may include two hypotheses. The first hypothesis may be associated with a first CQI including an SI as an interference source, and the second hypothesis may be associated with the second CQI not including the SI as the interference source. For example, referring to FIG. 12, the network entity (base station 1204) may, at 1234, receive, from the UE 1202, a CSI report. The CSI report may include two hypotheses. The first hypothesis may be associated with a first CQI including an SI as an interference source, and the second hypothesis may be associated with the second CQI not including the SI as the interference source. In some aspects, 1818 may be performed by the operation mode component 199.

In some aspects, the SBFD time and frequency configuration (at 1802) may include a semi-static network SBFD time and frequency indication indicating at least a part of the resources as FD resources, and the network entity may, at 1810, transmit, to the UE, a secondary signaling over the FD resources. The secondary signaling includes a UE mode indicator indicating the UE operation mode corresponding to the FD resources or HD resources. For example, referring to FIGS. 11 and 12, the SBFD time and frequency configuration (at 1206) may include a semi-static network SBFD time and frequency indication (SBFD indication 1130) indicating at least a part of the resources as FD resources (e.g., symbol 1110), and the network entity (base station 1204) may, at 1216, transmit, to the UE 1202, a secondary signaling (secondary signaling 1140) over the FD resources (e.g., symbol 1110). The secondary signaling includes a UE mode indicator indicating the UE operation mode corresponding to the FD resources or HD resources. In some aspects, 1810 may be performed by the operation mode component 199.

In some aspects, the UE mode indicator may include one of: a bitmap indication per symbol or per slot, a start index indicating a start slot index and a length of a window where the UE operation mode is applicable, or a pattern index identifying one bitmap pattern from a plurality of bitmap patterns in a pre-configured table for each slot.

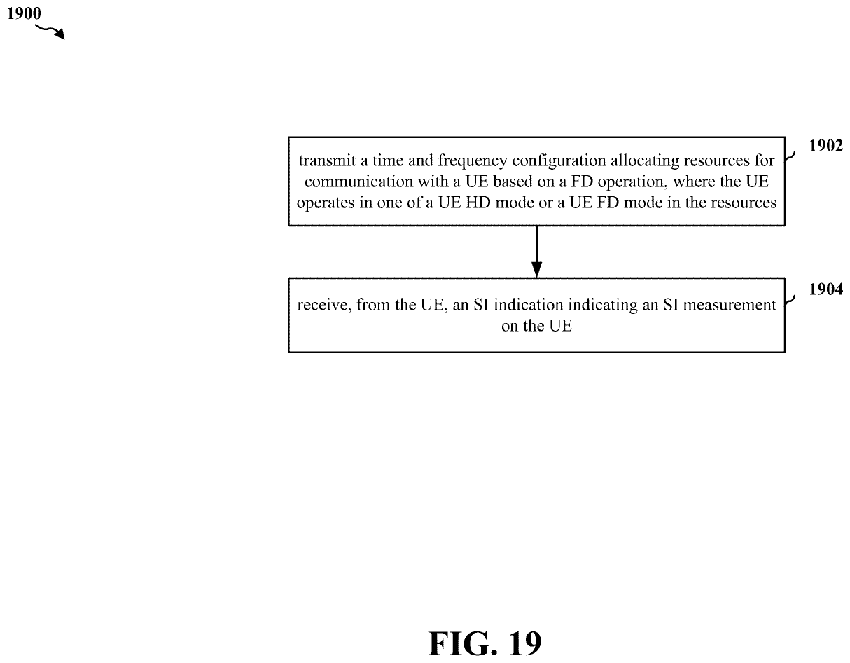

FIG. 19 is a flowchart 1900 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 2102 in the hardware implementation of FIG. 21). By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 19, at 1902, the network entity may transmit a time and frequency configuration allocating resources for communication with a UE based on a FD operation, where the UE operates in one of a UE HD mode or a UE FD mode in the resources. The UE may be the UE 104, 350, 1202, or the apparatus 2104 in the hardware implementation of FIG. 21. FIGS. 8, 9, 10, 11, and 12 illustrate various aspects of the steps in connection with flowchart 1900. For example, referring to FIG. 12, the network entity (base station 1204) may transmit, at 1206, a time and frequency configuration allocating resources for communication with a UE 1202 based on a FD operation. The UE operates in one of a UE HD mode or a UE FD mode in the resources. In some aspects, 1902 may be performed by the operation mode component 199.

At 1904, the network entity may receive, from the UE, an SI indication indicating an SI measurement on the UE. For example, referring to FIG. 12, the network entity (base station 1204) may receive, at 1224, from the UE 1202, an SI indication indicating an SI measurement on the UE 1202. In some aspects, 1904 may be performed by the operation mode component 199.

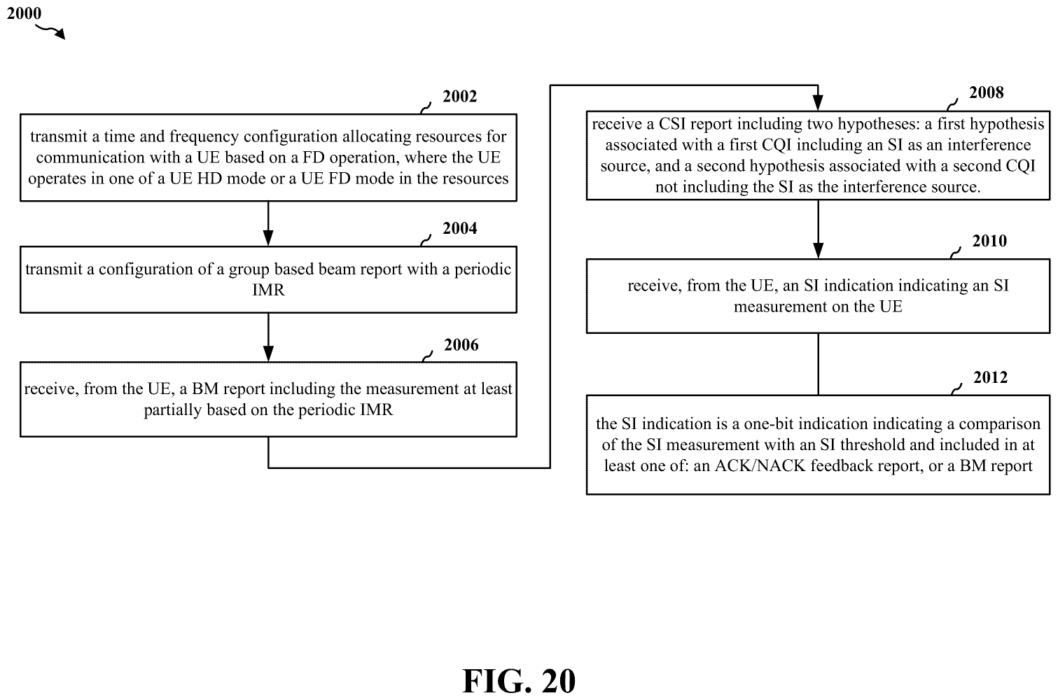

FIG. 20 is a flowchart 2000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 2102 in the hardware implementation of FIG. 21). By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

As shown in FIG. 20, at 2002, the network entity may transmit a time and frequency configuration allocating resources for communication with a UE based on a FD operation, where the UE operates in one of a UE HD mode or a UE FD mode in the resources. The UE may be the UE 104, 350, 1202, or the apparatus 2104 in the hardware implementation of FIG. 21. FIGS. 8, 9, 10, 11, and 12 illustrate various aspects of the steps in connection with flowchart 2000. For example, referring to FIG. 12, the network entity (base station 1204) may transmit, at 1206, a time and frequency configuration allocating resources for communication with a UE 1202 based on a FD operation. The UE operates in one of a UE HD mode or a UE FD mode in the resources. In some aspects, 2002 may be performed by the operation mode component 199.

At 2010, the network entity may receive, from the UE, an SI indication indicating an SI measurement on the UE. For example, referring to FIG. 12, the network entity (base station 1204) may receive, at 1224, from the UE 1202, an SI indication indicating an SI measurement on the UE 1202. In some aspects, 2010 may be performed by the operation mode component 199.

In some aspects, at 2012, the SI indication may be a one-bit indication indicating a comparison of the SI measurement with an SI threshold and may be included in at least one of: an ACK/NACK feedback report, or a beam BM report. The SI indication may be included in a bit at the end of the BM report, a new BM metric, or an existing BM metric in the BM report. For example, referring to FIG. 12, the SI indication (at 1224) may be a one-bit indication indicating a comparison of the SI measurement with an SI threshold and may be included in an ACK/NACK feedback report (1228) or a beam BM report (1226). The SI indication may be included in a bit at the end of the BM report, a new BM metric, or an existing BM metric in the BM report.

In some aspects, to receive the SI indication (at 2010), the network entity may receive the SI indication in the nearest BM report or the nearest ACK/NACK feedback report. For example, referring to FIG. 12, the network entity (base station 1204) may, at 1224, receive the SI indication in the nearest BM report (1226) or the nearest ACK/NACK feedback report (1228).

In some aspects, the network entity may, at 2004, transmit a configuration of a group based beam report with a periodic IMR and, at 2006, receive, from the UE, a BM report including the measurement at least partially based on the periodic IMR. For example, referring to FIG. 12, the network entity (base station 1204) may, at 1230, transmit a configuration of a group based beam report with a periodic IMR and, at 1232, receive, from the UE 1202, a BM report including the measurement at least partially based on the periodic IMR. In some aspects, 2004 and 2006 may be performed by the operation mode component 199.

In some aspects, the BM report may further include: in response to a UE mode indicator indicating the UE FD mode, a selected DL beam and a selected UL beam for the UE FD mode. For example, referring to FIG. 12, the BM report (at 1232) may further include: in response to a UE mode indicator indicating the UE FD mode, a selected DL beam and a selected UL beam for the UE FD mode.

In some aspects, the BM report may further include one or more of: in response to the UE mode indicator indicating the UE FD mode, a DL SINR of the UE, where the SINR includes the SI as an interference, and a DL RSRP measured with a UE UL beam. For example, referring to FIG. 12, the BM report (at 1232) may further include one or more of: in response to the UE mode indicator indicating the UE FD mode, a DL SINR of the UE 1202, where the SINR includes the SI as an interference, and a DL RSRP measured with a UE UL beam.

In some aspects, the selected DL beam and the selected UL beam may be based on the DL SINR and the DL RSRP measured with the UE UL beam. For example, referring to FIG. 12, the selected DL beam and the selected UL beam (in BM report at 1232) may be based on the DL SINR and the DL RSRP measured with the UE UL beam.

In some aspects, at 2008, the network entity may receive, from the UE, a CSI report. The CSI report may include two hypotheses. The first hypothesis may be associated with the first CQI including an SI as an interference source, and the second hypothesis may be associated with the second CQI not including the SI as the interference source. For example, referring to FIG. 12, the network entity (base station 1204) may receive, at 1234, from the UE 1202, a CSI report. The CSI report may include two hypotheses. The first hypothesis may be associated with the first CQI including an SI as an interference source, and the second hypothesis may be associated with the second CQI not including the SI as the interference source. In some aspects, 2008 may be performed by the operation mode component 199.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include at least one cellular baseband processor (or processing circuitry) 2124 (also referred to as a modem) coupled to one or more transceivers 2122 (e.g., cellular RF transceiver). The cellular baseband processor(s) (or processing circuitry) 2124 may include at least one on-chip memory (or memory circuitry) 2124′. In some aspects, the apparatus 2104 may further include one or more subscriber identity modules (SIM) cards 2120 and at least one application processor (or processing circuitry) 2106 coupled to a secure digital (SD) card 2108 and a screen 2110. The application processor(s) (or processing circuitry) 2106 may include on-chip memory (or memory circuitry) 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor(s) (or processing circuitry) 2124 communicates through the transceiver(s) 2122 via one or more antennas 2180 with the UE 104 and/or with an RU associated with a network entity 2102. The cellular baseband processor(s) (or processing circuitry) 2124 and the application processor(s) (or processing circuitry) 2106 may each include a computer-readable medium/memory (or memory circuitry) 2124′, 2106′, respectively. The additional memory modules 2126 may also be considered a computer-readable medium/memory (or memory circuitry). Each computer-readable medium/memory (or memory circuitry) 2124′, 2106′, 2126 may be non-transitory. The cellular baseband processor(s) (or processing circuitry) 2124 and the application processor(s) (or processing circuitry) 2106 are each responsible for general processing, including the execution of software stored on the computer-readable medium/memory (or memory circuitry). The software, when executed by the cellular baseband processor(s) (or processing circuitry) 2124/application processor(s) (or processing circuitry) 2106, causes the cellular baseband processor(s) (or processing circuitry) 2124/application processor(s) (or processing circuitry) 2106 to perform the various functions described supra. The cellular baseband processor(s) (or processing circuitry) 2124 and the application processor(s) (or processing circuitry) 2106 are configured to perform the various functions described supra based at least in part of the information stored in the memory (or memory circuitry). That is, the cellular baseband processor(s) (or processing circuitry) 2124 and the application processor(s) (or processing circuitry) 2106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 2124/application processor(s) (or processing circuitry) 2106 when executing software. The cellular baseband processor(s) (or processing circuitry) 2124/application processor(s) (or processing circuitry) 2106 may be a component of the UE 350 and may include the at least one memory 360 and/or at least one of the TX processor 368, the RX processor 356, and the controller/processor 359. In one configuration, the apparatus 2104 may be at least one processor chip (modem and/or application) and include just the cellular baseband processor(s) (or processing circuitry) 2124 and/or the application processor(s) (or processing circuitry) 2106, and in another configuration, the apparatus 2104 may be the entire UE (e.g., see UE 350 of FIG. 3) and include the additional modules of the apparatus 2104.

As discussed supra, in some aspects, the component 198 may be configured to receive an SBFD time and frequency configuration allocating resources for communication with a network entity based on an SBFD mode; obtain a UE operation mode for the resources, wherein the UE operation mode is one of a UE FD mode or a UE HD mode; and communicate with the network entity in the resources allocated for the UE based on the UE operation mode. In some aspects, the component 198 may be configured to receive a time and frequency configuration allocating resources for communication with a network entity based on an FD operation, where the UE operates in one of a UE HD mode or a UE FD mode in the resources; perform, in response to the time and frequency configuration, an SI measurement for the UE; and report, to the network entity, an SI indication indicating the SI measurement. The component 198 may be further configured to perform any of the aspects described in connection with the flowcharts in FIG. 13, FIG. 14, FIG. 15 and FIG. 16, and/or performed by the UE 1202 in FIG. 12. The component 198 may be within the cellular baseband processor(s) (or processing circuitry) 2124, the application processor(s) (or processing circuitry) 2106, or both the cellular baseband processor(s) (or processing circuitry) 2124 and the application processor(s) (or processing circuitry) 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2104 may include a variety of components configured for various functions. In one configuration, the apparatus 2104, and in particular the cellular baseband processor(s) (or processing circuitry) 2124 and/or the application processor(s) (or processing circuitry) 2106. In some aspects, the apparatus 2104 may include means for receiving an SBFD time and frequency configuration allocating resources for communication with a network entity based on an SBFD mode, means for obtaining a UE operation mode for the resources, wherein the UE operation mode is one of a UE FD mode or a UE HD mode, and means for communicating with the network entity in the resources allocated for the UE based on the UE operation mode. In some aspects, the apparatus 2104 may include means for receiving a time and frequency configuration allocating resources for communication with a network entity based on an FD operation, where the UE operates in one of a UE HD mode or a UE FD mode in the resources, means for performing, in response to the time and frequency configuration, an SI measurement for the UE, and means for reporting, to the network entity, an SI indication indicating the SI measurement. The apparatus 2104 may further include means for performing any of the aspects described in connection with the flowcharts in FIG. 13, FIG. 14, FIG. 15, FIG. 16, and/or aspects performed by the UE 1202 in FIG. 12. The means may be the component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

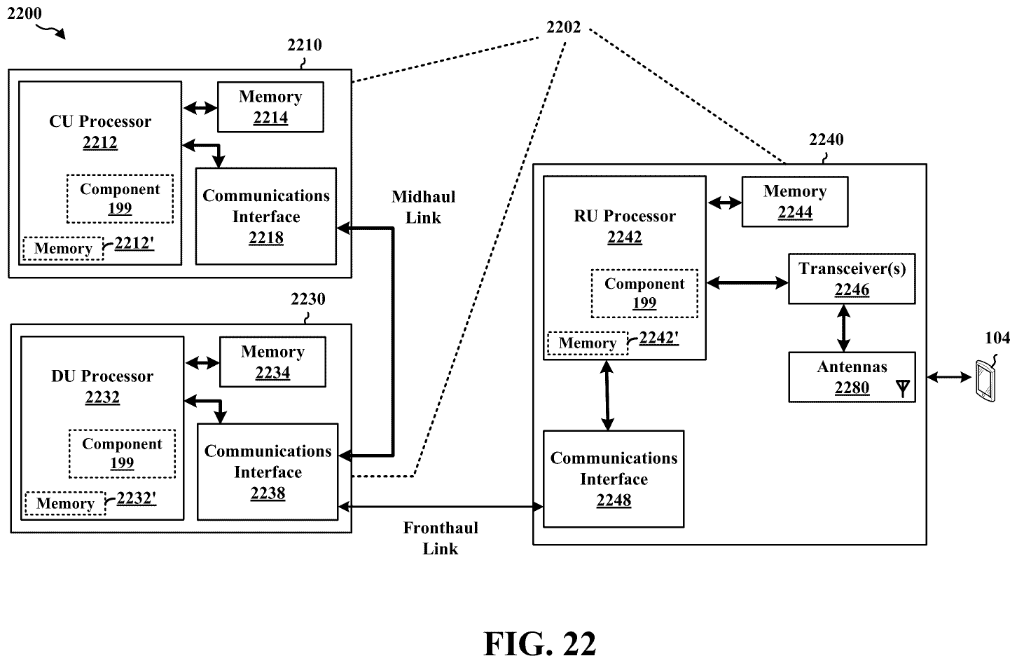

FIG. 22 is a diagram 2200 illustrating an example of a hardware implementation for a network entity 2202. The network entity 2202 may be a BS, a component of a BS, or may implement BS functionality. The network entity 2202 may include at least one of a CU 2210, a DU 2230, or an RU 2240. For example, depending on the layer functionality handled by the component 199, the network entity 2202 may include the CU 2210; both the CU 2210 and the DU 2230; each of the CU 2210, the DU 2230, and the RU 2240; the DU 2230; both the DU 2230 and the RU 2240; or the RU 2240. The CU 2210 may include at least one CU processor (or processing circuitry) 2212. The CU processor(s) (or processing circuitry) 2212 may include on-chip memory (or memory circuitry) 2212′. In some aspects, the CU 2210 may further include additional memory modules 2214 and a communications interface 2218. The CU 2210 communicates with the DU 2230 through a midhaul link, such as an F1 interface. The DU 2230 may include at least one DU processor (or processing circuitry) 2232. The DU processor(s) (or processing circuitry) 2232 may include on-chip memory (or memory circuitry) 2232′. In some aspects, the DU 2230 may further include additional memory modules 2234 and a communications interface 2238. The DU 2230 communicates with the RU 2240 through a fronthaul link. The RU 2240 may include at least one RU processor (or processing circuitry) 2242. The RU processor(s) (or processing circuitry) 2242 may include on-chip memory (or memory circuitry) 2242′. In some aspects, the RU 2240 may further include additional memory modules 2244, one or more transceivers 2246, antennas 2280, and a communications interface 2248. The RU 2240 communicates with the UE 104. The on-chip memory (or memory circuitry) 2212′, 2232′, 2242′ and the additional memory modules 2214, 2234, 2244 may each be considered a computer-readable medium/memory (or memory circuitry). Each computer-readable medium/memory (or memory circuitry) may be non-transitory. Each of the processors (or processing circuitry) 2212, 2232, 2242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, in some aspects, the component 199 may be configured to transmit an SBFD time and frequency configuration allocating resources for communication with a UE based on an SBFD mode; and communicate with the UE in the resources allocated for the UE based on a UE operation mode for the resources, where the UE operation mode is one of a UE FD mode or a UE HD mode. In some aspects, the component 199 may be configured to transmit a time and frequency configuration allocating resources for communication with a UE based on an FD operation, where the UE operates in one of a UE HD mode or a UE FD mode in the resources; and receive, from the UE, an SI indication indicating an SI measurement on the UE. The component 199 may be further configured to perform any of the aspects described in connection with the flowcharts in FIG. 17 and FIG. 18, and/or performed by the base station 1204 in FIG. 12. The component 199 may be within one or more processors (or processing circuitry) of one or more of the CU 2210, DU 2230, and the RU 2240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2202 may include a variety of components configured for various functions. In one configuration, the network entity 2202 includes means for transmitting an SBFD time and frequency configuration allocating resources for communication with a UE based on an SBFD mode, and means for communicating with the UE in the resources allocated for the UE based on a UE operation mode for the resources, where the UE operation mode is one of a UE FD mode or a UE HD mode. In one configuration, the network entity 2202 includes means for transmitting a time and frequency configuration allocating resources for communication with a UE based on an FD operation, where the UE operates in one of a UE HD mode or a UE FD mode in the resources, and means for receiving, from the UE, an SI indication indicating an SI measurement on the UE. The network entity 2202 may further include means for performing any of the aspects described in connection with the flowcharts in FIG. 17, FIG. 18, 19, FIG. 20, and/or aspects performed by the base station 1204 in FIG. 12. The means may be the component 199 of the network entity 2202 configured to perform the functions recited by the means. As described supra, the network entity 2202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving an SBFD time and frequency configuration allocating resources for communication with a network entity based on an SBFD mode; obtaining a UE operation mode for the resources, wherein the UE operation mode is one of a UE FD mode or a UE HD mode; and communicating with the network entity in the resources allocated for the UE based on the UE operation mode. By enabling different modes of UE operation, the methods allow UEs to interact flexibly with various cell types and configurations to improve the efficiency of resource utilization. In some examples, by enabling the UE to measure the SI and report the results to the network following an operation mode indication, the methods allow for quick adjustments in operational parameters, such as antenna configurations and transmission powers, to optimize its performance based on real-time conditions such as traffic demand or signal interference, thereby ensuring communication reliability and maintaining optimal performance.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving a subband full duplex (SBFD) time and frequency configuration allocating resources for communication with a network entity based on an SBFD mode; obtaining a UE operation mode for the resources, wherein the UE operation mode is one of a UE full-duplex (FD) mode or a UE half-duplex (HD) mode; and communicating with the network entity in the resources allocated for the UE based on the UE operation mode.

Aspect 2 is the method of aspect 1, where the method further includes receiving a configured grant allocating uplink resources for uplink transmissions; and receiving semi-persistent scheduling (SPS) allocating downlink resources for reception of downlink transmissions, wherein obtaining the UE operation mode for the resources comprises: identifying a first set of occasions in which the uplink resources of the configured grant overlap with the downlink resources of the SPS, and wherein communicating with the network entity comprises: communicating with the network entity based on a first set of one or more operation parameters associated with a first UE operation mode in the first set of occasions and a second set of one or more operation parameters associated with a second UE operation mode in the second set of one or more occasions.

Aspect 3 is the method of aspect 2, wherein the one or more operation parameters associated with the UE operation mode comprise one or more of: a downlink (DL) modulation and coding scheme (MCS), an uplink (UL) MCS, a DL beam for the UE, a number of layers for communicating with the network entity, a precoding matrix indicator (PMI), a UL beam for the UE, UL power control (PC) parameters for the UE, or UL timing advance (TA).

Aspect 4 is the method of any of aspects 1 to 3, wherein obtaining the UE operation mode comprises: receiving an indication of the UE operation mode for the resources in the SBFD time and frequency configuration.

Aspect 5 is the method of any of aspects 1 to 3, wherein obtaining the UE operation mode further comprises: setting a default operation mode of the UE operation mode as the UE FD mode in response to the SBFD time and frequency configuration not indicating the UE operation mode.

Aspect 6 is the method of aspect 4, wherein the indication of the UE operation mode comprises a one-bit indicator, wherein the one-bit indicator is comprised in one of: scheduling downlink control information (DCI), non-scheduling DCI, group-common (GC) DCI, a radio resource control (RRC) message, or a medium access control (MAC)-control element (MAC-CE).

Aspect 7 is the method of aspect 6, wherein communicating with the network entity comprises: applying a set of one or more operation parameters associated with the UE operation mode, and communicating with the network entity based on the set of one or more operation parameters, wherein the one or more operation parameters comprise one or more of: a downlink (DL) modulation and coding scheme (MCS), an uplink (UL) MCS, a DL beam for the UE, a number of layers for communicating with the network entity, a precoding matrix indicator (PMI), a UL beam for the UE, UL power control (PC) parameters for the UE, or UL timing advance (TA).

Aspect 8 is the method of aspect 6, where the method further includes performing, in response to a reception of the indication of the UE operation mode in the UE FD mode, a self-interference (SI) measurement on the UE to obtain an SI indication; and reporting, to the network entity, the SI indication.

Aspect 9 is the method of aspect 8, wherein the SI indication is a one-bit indication indicating a comparison of the SI measurement with an SI threshold and included in at least one of: an acknowledgment or negative acknowledgment (ACK/NACK) feedback report, or a beam management (BM) report, wherein the SI indication is included in a bit at an end of the BM report, a new BM metric, or an existing BM metric in the BM report.

Aspect 10 is the method of aspect 8, wherein reporting the SI indication comprises: reporting the SI indication in a nearest beam management (BM) report or a nearest ACK/NACK feedback report.

Aspect 11 is the method of aspect 8, where the method further includes receiving a configuration of a group based beam report with a periodic interference measurement resource (IMR) for the SI measurement; and transmitting, to the network entity, a beam management (BM) report including the SI measurement at least partially based on the periodic IMR.

Aspect 12 is the method of aspect 11, wherein the BM report further comprises: in response to the indication of the UE operation mode indicating the UE FD mode, a selected DL beam and a selected UL beam for the UE FD mode.

Aspect 13 is the method of aspect 12, wherein the BM report further comprises one or more of: in response to the indication of the UE operation mode indicating the UE FD mode, a DL signal-to-interference-plus-noise ratio (SINR) of the UE, wherein the SINR includes the SI as an interference, and a DL reference signal received power (RSRP) measured with a UE UL beam.

Aspect 14 is the method of aspect 13, wherein the selected DL beam and the selected UL beam are based on the DL SINR and the DL RSRP measured with the UE UL beam.

Aspect 15 is the method of aspect 11, where the method further includes transmitting, to the network entity, a channel state information (CSI) report, wherein the CSI report comprises two hypotheses comprising: a first hypothesis associated with a first channel quality indicator (CQI) including an SI as an interference source, and a second hypothesis associated with a second CQI not including the SI as the interference source.

Aspect 16 is the method of any of aspects 1 to 15, wherein the SBFD time and frequency configuration comprises a semi-static network SBFD time and frequency indication indicating at least a part of the resources as FD resources, wherein obtaining the UE operation mode includes: receiving, from the network entity, a secondary signaling over the FD resources; and obtaining, based on the secondary signaling, a UE mode indicator indicating the UE operation mode corresponding to the FD resources or HD resources.

Aspect 17 is the method of aspect 16, wherein the UE mode indicator includes one of: a bitmap indication per symbol or per slot, a start index indicating a start slot index and a length of a window where the UE operation mode is applicable, or a pattern index identifying one bitmap pattern from a plurality of bitmap patterns in a pre-configured table for each slot.

Aspect 18 is an apparatus for wireless communication at a UE, comprising: a processing system that includes processor circuitry and memory circuitry that stores code and is coupled with the processor circuitry, the processing system configured to cause the UE to perform the method of one or more of aspects 1-17.

Aspect 19 is an apparatus for wireless communication at a UE, comprising: at least one memory; and at least one processor coupled to the at least one memory and, where the at least one processor, individually or in any combination, is configured to perform the method of any of aspects 1-17.

Aspect 20 is the apparatus for wireless communication at a UE, comprising means for performing each step in the method of any of aspects 1-17.

Aspect 21 is an apparatus of any of aspects 18-20, further comprising a transceiver configured to receive or to transmit in association with the method of any of aspects 1-17.

Aspect 22 is a computer-readable medium (e.g., a non-transitory computer-readable medium) storing computer executable code at a UE, the code when executed by at least one processor causes the at least one processor to, individually or in any combination, perform the method of any of aspects 1-17.

Aspect 23 is a method of wireless communication at a UE. The method includes receiving a time and frequency configuration allocating resources for communication with a network entity based on a full-duplex (FD) operation, wherein the UE operates in one of a UE half-duplex (HD) mode or a UE FD mode in the resources; performing, in response to the time and frequency configuration, a self-interference (SI) measurement for the UE; and reporting, to the network entity, an SI indication indicating the SI measurement.

Aspect 24 is the method of aspect 23, wherein the SI indication is a one-bit indication indicating a comparison of the SI measurement with an SI threshold and included in at least one of: an acknowledgment or negative acknowledgment (ACK/NACK) feedback report, or a beam management (BM) report, wherein the SI indication is included in a bit at an end of the BM report, a new BM metric, or an existing BM metric in the BM report.

Aspect 25 is the method of aspect 24, wherein reporting the SI indication comprises: reporting the SI indication in a nearest beam management (BM) report or a nearest ACK/NACK feedback report.

Aspect 26 is the method of any of aspects 23 to 25, where the method further includes receiving a configuration of a group based beam report with a periodic interference measurement resource (IMR); and transmitting, to the network entity, a beam management (BM) report including the measurement at least partially based on the periodic IMR.

Aspect 27 is the method of aspect 26, wherein the BM report further comprises: in response to a UE mode indicator indicating the UE FD mode, a selected DL beam and a selected UL beam for the UE FD mode.

Aspect 28 is the method of aspect 27, wherein the BM report further comprises one or more of: in response to the UE mode indicator indicating the UE FD mode, a DL signal-to-interference-plus-noise ratio (SINR) of the UE, wherein the SINR includes the SI as an interference, and a DL reference signal received power (RSRP) measured with a UE UL beam.

Aspect 29 is the method of aspect 28, wherein the selected DL beam and the selected UL beam are based on the DL SINR and the DL RSRP measured with the UE UL beam.

Aspect 30 is the method of any of aspects 26 to 29, where the method further includes transmitting, to the network entity, a channel state information (CSI) report, wherein the CSI report comprises two hypotheses comprising: a first hypothesis associated with a first channel quality indicator (CQI) including an SI as an interference source, and a second hypothesis associated with a second CQI not including the SI as the interference source.

Aspect 31 is an apparatus for wireless communication at a UE, comprising: a processing system that includes processor circuitry and memory circuitry that stores code and is coupled with the processor circuitry, the processing system configured to cause the UE to perform the method of one or more of aspects 23-30.

Aspect 32 is an apparatus for wireless communication at a UE, comprising: at least one memory; and at least one processor coupled to the at least one memory and, where the at least one processor, individually or in any combination, is configured to perform the method of any of aspects 23-30.

Aspect 33 is the apparatus for wireless communication at a UE, comprising means for performing each step in the method of any of aspects 23-30.

Aspect 34 is an apparatus of any of aspects 31-33, further comprising a transceiver configured to receive or to transmit in association with the method of any of aspects 23-30.

Aspect 35 is a computer-readable medium (e.g., a non-transitory computer-readable medium) storing computer executable code at a UE, the code when executed by at least one processor causes the at least one processor to, individually or in any combination, perform the method of any of aspects 23-30.

Aspect 36 is a method of wireless communication at a network entity. The method includes transmitting a subband full duplex (SBFD) time and frequency configuration allocating resources for communication with a user equipment (UE) based on an SBFD mode; and communicating with the UE in the resources allocated for the UE based on a UE operation mode for the resources, wherein the UE operation mode is one of a UE full-duplex (FD) mode or a UE half-duplex (HD) mode.

Aspect 37 is the method of aspect 36, where the method further includes transmitting a configured grant allocating uplink resources for uplink transmissions; transmitting semi-persistent scheduling (SPS) allocating downlink resources for reception of downlink transmissions, wherein the UE operation mode for the resources is based on a first set of occasions in which the uplink resources of the configured grant overlaps with the downlink resources of the SPS, and wherein communicating with the UE comprises: communicating with the UE based on a first set of one or more operation parameters associated with a first UE operation mode in the first set of occasions and a second set of one or more operation parameters associated with a second UE operation mode in the second set of one or more occasions.

Aspect 38 is the method of aspect 37, wherein the one or more operation parameters associated with the UE operation mode comprise one or more of: downlink (DL) modulation and coding scheme (MCS), an uplink (UL) MCS, a DL beam for the UE, a number of layers for communicating with the network entity, a precoding matrix indicator (PMI), a UL beam for the UE, UL power control (PC) parameters for the UE, or UL timing advance (TA).

Aspect 39 is the method of any of aspects 36 to 38, where the method further includes transmitting, to the UE, an indication of the UE operation mode for the resource in the SBFD time and frequency configuration.

Aspect 40 is the method of aspect 39, wherein the indication of the UE operation mode comprises a one-bit indicator, wherein the one-bit indicator is comprised in one of: scheduling downlink control information (DCI), non-scheduling DCI, group-common (GC) DCI, a radio resource control (RRC) message, or a medium access control (MAC)-control element (MAC-CE).

Aspect 41 is the method of aspect 40, where the method further includes receiving, from the UE, a self-interference (SI) indication indicating an SI measurement on the UE.

Aspect 42 is the method of aspect 41, wherein the SI indication is a one-bit indication indicating a comparison of the SI measurement with an SI threshold and included in at least one of: an acknowledgment or negative acknowledgment (ACK/NACK) feedback report, or a beam management (BM) report, wherein the SI indication is included in a bit at an end of the BM report, a new BM metric, or an existing BM metric in the BM report.

Aspect 43 is the method of aspect 42, wherein the SI indication is included in a nearest BM report or a nearest ACK/NACK feedback report.

Aspect 44 is the method of any of aspects 41 to 43, where the method further includes transmitting a configuration of a group based beam report with a periodic interference measurement resource (IMR) for the SI measurement; and receiving, from the UE, a beam management (BM) report including the SI measurement at least partially based on the periodic IMR.

Aspect 45 is the method of aspect 44, wherein the BM report further comprises: in response to the indication of the UE operation mode indicating the UE FD mode, a selected DL beam and a selected UL beam for the UE FD mode.

Aspect 46 is the method of aspect 45, wherein the BM report further comprises one or more of: in response to the indication of the UE operation mode indicating the UE FD mode, a DL signal-to-interference-plus-noise ratio (SINR) of the UE, wherein the SINR includes the SI as an interference, and a DL reference signal received power (RSRP) measured with a UE UL beam.

Aspect 47 is the method of aspect 46, wherein the selected DL beam and the selected UL beam are based on the DL SINR and the DL RSRP measured with the UE UL beam.

Aspect 48 is the method of any of aspects 44 to 47, where the method further includes receiving, from the UE, a channel state information (CSI) report, wherein the CSI report comprises two hypothesis comprising: a first hypothesis associated with a first channel quality indicator (CQI) including an SI as an interference source, and a second hypothesis associated with a second CQI not including the SI as the interference source.

Aspect 49 is the method of any of aspects 36 to 48, wherein the SBFD time and frequency configuration comprises a semi-static network SBFD time and frequency indication indicating at least a part of the resources as FD resources, wherein the method further comprises: transmitting, to the UE, a secondary signaling over the FD resources, wherein the secondary signaling includes a UE mode indicator indicating the UE operation mode corresponding to the FD resources or HD resources.

Aspect 50 is the method of aspect 49, wherein the UE mode indicator includes one of: a bitmap indication per symbol or per slot, a start index indicating a start slot index and a length of a window where the UE operation mode is applicable, or a pattern index identifying one bitmap pattern from a plurality of bitmap patterns in a pre-configured table for each slot.

Aspect 51 is an apparatus for wireless communication at a network entity, comprising: a processing system that includes processor circuitry and memory circuitry that stores code and is coupled with the processor circuitry, the processing system configured to cause the network entity to perform the method of one or more of aspects 36-50.

Aspect 52 is an apparatus for wireless communication at a network entity, comprising: at least one memory; and at least one processor coupled to the at least one memory and, where the at least one processor, individually or in any combination, is configured to perform the method of any of aspects 36-50.

Aspect 53 is the apparatus for wireless communication at a network entity, comprising means for performing each step in the method of any of aspects 36-50.

Aspect 54 is an apparatus of any of aspects 51-53, further comprising a transceiver configured to receive or to transmit in association with the method of any of aspects 36-50.

Aspect 55 is a computer-readable medium (e.g., a non-transitory computer-readable medium) storing computer executable code at a network entity, the code when executed by at least one processor causes the at least one processor to, individually or in any combination, perform the method of any of aspects 36-50.

Aspect 56 is a method of wireless communication at a network entity. The method includes transmitting a time and frequency configuration allocating resources for communication with a user equipment (UE) based on a full-duplex (FD) operation, wherein the UE operates in one of a UE half-duplex (HD) mode or a UE FD mode in the resources; and receiving, from the UE, a self-interference (SI) indication indicating an SI measurement on the UE.

Aspect 57 is the method of aspect 56, wherein the SI indication is a one-bit indication indicating a comparison of the SI measurement with an SI threshold and included in at least one of: an acknowledgment or negative acknowledgment (ACK/NACK) feedback report, or a beam management (BM) report, wherein the SI indication is included in a bit at an end of the BM report, a new BM metric, or an existing BM metric in the BM report.

Aspect 58 is the method of aspect 57, wherein receiving the SI indication comprises: receiving the SI indication in a nearest beam management (BM) report or a nearest ACK/NACK feedback report.

Aspect 59 is the method of aspect 56, where the method further includes transmitting a configuration of a group based beam report with a periodic interference measurement resource (IMR); and receiving, from the UE, a beam management (BM) report including the measurement at least partially based on the periodic IMR.

Aspect 60 is the method of aspect 59, wherein the BM report further comprises: in response to a UE mode indicator indicating the UE FD mode, a selected DL beam and a selected UL beam for the UE FD mode.

Aspect 61 is the method of aspect 60, wherein the BM report further comprises one or more of: in response to the UE mode indicator indicating the UE FD mode, a DL signal-to-interference-plus-noise ratio (SINR) of the UE, wherein the SINR includes the SI as an interference, and a DL reference signal received power (RSRP) measured with a UE UL beam.

Aspect 62 is the method of aspect 61, wherein the selected DL beam and the selected UL beam are based on the DL SINR and the DL RSRP measured with the UE UL beam.

Aspect 63 is the method of any of aspects 59 to 62, where the method further includes receiving, from the UE, a channel state information (CSI) report, wherein the CSI report comprises two hypotheses comprising: a first hypothesis associated with a first channel quality indicator (CQI) including an SI as an interference source, and a second hypothesis associated with a second CQI not including the SI as the interference source.

Aspect 64 is an apparatus for wireless communication at a network entity, comprising: a processing system that includes processor circuitry and memory circuitry that stores code and is coupled with the processor circuitry, the processing system configured to cause the network entity to perform the method of one or more of aspects 56-63.

Aspect 65 is an apparatus for wireless communication at a network entity, comprising: at least one memory; and at least one processor coupled to the at least one memory and, where the at least one processor, individually or in any combination, is configured to perform the method of any of aspects 56-63.

Aspect 66 is the apparatus for wireless communication at a network entity, comprising means for performing each step in the method of any of aspects 56-63.

Aspect 67 is an apparatus of any of aspects 64-66, further comprising a transceiver configured to receive or to transmit in association with the method of any of aspects 56-63.

Aspect 68 is a computer-readable medium (e.g., a non-transitory computer-readable medium) storing computer executable code at a network entity, the code when executed by at least one processor causes the at least one processor to, individually or in any combination, perform the method of any of aspects 56-63.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive a subband full duplex (SBFD) time and frequency configuration allocating resources for communication with a network entity based on an SBFD mode;
obtain a UE operation mode for the resources, wherein the UE operation mode is one of a UE full-duplex (FD) mode or a UE half-duplex (HD) mode; and
communicate with the network entity in the resources allocated for the UE based on the UE operation mode.

2. The apparatus of claim 1, further comprising a transceiver coupled to the at least one processor, wherein to receive the SBFD time and frequency configuration, the at least one processor, individually or in any combination, is configured to receive the SBFD time and frequency configuration via the transceiver, wherein the at least one processor, individually or in combination, is further configured to cause the UE to:
receive a configured grant allocating uplink resources for uplink transmissions; and
receive semi-persistent scheduling (SPS) allocating downlink resources for reception of downlink transmissions,
wherein to obtain the UE operation mode for the resources, the at least one processor, individually or in combination, is configured to cause the UE to:
identify a first set of occasions in which the uplink resources of the configured grant overlap with the downlink resources of the SPS, and
wherein to communicate with the network entity, the at least one processor, individually or in combination, is configured to cause the UE to:
communicate with the network entity based on a first set of one or more operation parameters associated with a first UE operation mode in the first set of occasions and a second set of one or more operation parameters associated with a second UE operation mode in the second set of one or more occasions.

3. The apparatus of claim 2, wherein the one or more operation parameters associated with the UE operation mode comprise one or more of:
a downlink (DL) modulation and coding scheme (MCS),
an uplink (UL) MCS,
a DL beam for the UE,
a number of layers for communicating with the network entity,
a precoding matrix indicator (PMI),
a UL beam for the UE,
UL power control (PC) parameters for the UE, or
UL timing advance (TA).

4. The apparatus of claim 1, wherein to obtain the UE operation mode, the at least one processor, individually or in combination, is configured to cause the UE to:
receive an indication of the UE operation mode for the resources in the SBFD time and frequency configuration.

5. The apparatus of claim 1, wherein to obtain the UE operation mode, the at least one processor, individually or in combination, is further configured to cause the UE to:
set a default operation mode of the UE operation mode as the UE FD mode in response to the SBFD time and frequency configuration not indicating the UE operation mode.

6. The apparatus of claim 4, wherein the indication of the UE operation mode comprises a one-bit indicator, wherein the one-bit indicator is comprised in one of:
scheduling downlink control information (DCI),
non-scheduling DCI,
group-common (GC) DCI,
a radio resource control (RRC) message, or
a medium access control (MAC)-control element (MAC-CE).

7. The apparatus of claim 6, wherein to communicate with the network entity, the at least one processor, individually or in combination, is configured to cause the UE to:
apply a set of one or more operation parameters associated with the UE operation mode, and
communicate with the network entity based on the set of one or more operation parameters, wherein the one or more operation parameters comprise one or more of:
a downlink (DL) modulation and coding scheme (MCS),
an uplink (UL) MCS,
a DL beam for the UE,
a number of layers for communicating with the network entity,
a precoding matrix indicator (PMI),
a UL beam for the UE,
UL power control (PC) parameters for the UE, or
UL timing advance (TA).

8. The apparatus of claim 6, wherein the at least one processor, individually or in combination, is further configured to cause the UE to:
perform, in response to a reception of the indication of the UE operation mode in the UE FD mode, a self-interference (SI) measurement on the UE to obtain an SI indication; and
report, to the network entity, the SI indication.

9. The apparatus of claim 8, wherein the SI indication is a one-bit indication indicating a comparison of the SI measurement with an SI threshold and included in at least one of:
an acknowledgment or negative acknowledgment (ACK/NACK) feedback report, or
a beam management (BM) report, wherein the SI indication is included in a bit at an end of the BM report, a new BM metric, or an existing BM metric in the BM report.

10. The apparatus of claim 8, wherein to report the SI indication, the at least one processor, individually or in combination, is configured to cause the UE to:
report the SI indication in a nearest beam management (BM) report or a nearest ACK/NACK feedback report.

11. The apparatus of claim 8, wherein the at least one processor, individually or in combination, is further configured to cause the UE to:
receive a configuration of a group based beam report with a periodic interference measurement resource (IMR) for the SI measurement; and
transmit, to the network entity, a beam management (BM) report including the SI measurement at least partially based on the periodic IMR.

12. The apparatus of claim 11, wherein the BM report further comprises:
in response to the indication of the UE operation mode indicating the UE FD mode, a selected DL beam and a selected UL beam for the UE FD mode.

13. The apparatus of claim 12, wherein the BM report further comprises one or more of:
in response to the indication of the UE operation mode indicating the UE FD mode, a DL signal-to-interference-plus-noise ratio (SINR) of the UE, wherein the SINR includes the SI as an interference, and
a DL reference signal received power (RSRP) measured with a UE UL beam.

14. The apparatus of claim 13, wherein the selected DL beam and the selected UL beam are based on the DL SINR and the DL RSRP measured with the UE UL beam.

15. The apparatus of claim 11, wherein the at least one processor, individually or in combination, is further configured to cause the UE to:
transmit, to the network entity, a channel state information (CSI) report, wherein the CSI report comprises two hypotheses comprising: a first hypothesis associated with a first channel quality indicator (CQI) including an SI as an interference source, and a second hypothesis associated with a second CQI not including the SI as the interference source.

16. The apparatus of claim 1, wherein the SBFD time and frequency configuration comprises a semi-static network SBFD time and frequency indication indicating at least a part of the resources as FD resources, wherein to obtain the UE operation mode, the at least one processor, individually or in combination, is configured to cause the UE to:
receive, from the network entity, a secondary signaling over the FD resources; and
obtain, based on the secondary signaling, a UE mode indicator indicating the UE operation mode corresponding to the FD resources or HD resources.

17. The apparatus of claim 16, wherein the UE mode indicator includes one of:
a bitmap indication per symbol or per slot,
a start index indicating a start slot index and a length of a window where the UE operation mode is applicable, or
a pattern index identifying one bitmap pattern from a plurality of bitmap patterns in a pre-configured table for each slot.

18. An apparatus of wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive a time and frequency configuration allocating resources for communication with a network entity based on a full-duplex (FD) operation, wherein the UE operates in one of a UE half-duplex (HD) mode or a UE FD mode in the resources;
perform, in response to the time and frequency configuration, a self-interference (SI) measurement for the UE; and
report, to the network entity, an SI indication indicating the SI measurement.

19. The apparatus of claim 18, further comprising a transceiver coupled to the at least one processor, wherein to receive the time and frequency configuration, the at least one processor, individually or in any combination, is configured to receive the time and frequency configuration via the transceiver, wherein the SI indication is a one-bit indication indicating a comparison of the SI measurement with an SI threshold and included in at least one of:
an acknowledgment or negative acknowledgment (ACK/NACK) feedback report, or
a beam management (BM) report, wherein the SI indication is included in a bit at an end of the BM report, a new BM metric, or an existing BM metric in the BM report.

20. The apparatus of claim 19, wherein to report the SI indication, the at least one processor, individually or in any combination, is configured to cause the UE to:
report the SI indication in a nearest beam management (BM) report or a nearest ACK/NACK feedback report.

21. The apparatus of claim 18, wherein the at least one processor, individually or in any combination, is further configured to cause the UE to:
receive a configuration of a group based beam report with a periodic interference measurement resource (IMR); and
transmit, to the network entity, a beam management (BM) report including the measurement at least partially based on the periodic IMR.

22. The apparatus of claim 21, wherein the BM report further comprises:
in response to a UE mode indicator indicating the UE FD mode, a selected DL beam and a selected UL beam for the UE FD mode.

23. The apparatus of claim 22, wherein the BM report further comprises one or more of:
in response to the UE mode indicator indicating the UE FD mode, a DL signal-to-interference-plus-noise ratio (SINR) of the UE, wherein the SINR includes the SI as an interference, and
a DL reference signal received power (RSRP) measured with a UE UL beam.

24. The apparatus of claim 23, wherein the selected DL beam and the selected UL beam are based on the DL SINR and the DL RSRP measured with the UE UL beam.

25. The apparatus of claim 21, wherein the at least one processor, individually or in any combination, is further configured to cause the UE to:
transmit, to the network entity, a channel state information (CSI) report, wherein the CSI report comprises two hypotheses comprising: a first hypothesis associated with a first channel quality indicator (CQI) including an SI as an interference source, and a second hypothesis associated with a second CQI not including the SI as the interference source.

26. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
transmit a subband full duplex (SBFD) time and frequency configuration allocating resources for communication with a user equipment (UE) based on an SBFD mode; and
communicate with the UE in the resources allocated for the UE based on a UE operation mode for the resources, wherein the UE operation mode is one of a UE full-duplex (FD) mode or a UE half-duplex (HD) mode.

27. The apparatus of claim 26, further comprising a transceiver coupled to the at least one processor, wherein to transmit the SBFD time and frequency configuration, the at least one processor, individually or in any combination, is configured to transmit the SBFD time and frequency configuration via the transceiver, and wherein the at least one processor, individually or in any combination, is further configured to cause the network entity to:
transmit a configured grant allocating uplink resources for uplink transmissions; and
transmit semi-persistent scheduling (SPS) allocating downlink resources for reception of downlink transmissions,
wherein the UE operation mode for the resources is based on a first set of occasions in which the uplink resources of the configured grant overlaps with the downlink resources of the SPS, and wherein to communicate with the UE, the at least one processor, individually or in any combination, is configured to cause the network entity to:
communicate with the UE based on a first set of one or more operation parameters associated with a first UE operation mode in the first set of occasions and a second set of one or more operation parameters associated with a second UE operation mode in the second set of one or more occasions.

28. The apparatus of claim 27, wherein the one or more operation parameters associated with the UE operation mode comprise one or more of:
a downlink (DL) modulation and coding scheme (MCS),
an uplink (UL) MCS,
a DL beam for the UE,
a number of layers for communicating with the network entity,
a precoding matrix indicator (PMI),
a UL beam for the UE,
UL power control (PC) parameters for the UE, or
UL timing advance (TA).

29. An apparatus of wireless communication at a network entity, comprising:
at least one memory; and
at least one processor coupled to the at least one memory and, based at least in part on information stored in the at least one memory, the at least one processor, individually or in any combination, is configured to cause the network entity to:
transmit a time and frequency configuration allocating resources for communication with a user equipment (UE) based on a full-duplex (FD) operation, wherein the UE operates in one of a UE half-duplex (HD) mode or a UE FD mode in the resources; and
receive, from the UE, a self-interference (SI) indication indicating an SI measurement on the UE.

30. The apparatus of claim 29, further comprising a transceiver coupled to the at least one processor, wherein to transmit the time and frequency configuration, the at least one processor, individually or in any combination, is configured to transmit the time and frequency configuration via the transceiver, wherein the SI indication is a one-bit indication indicating a comparison of the SI measurement with an SI threshold and included in at least one of:
an acknowledgment or negative acknowledgment (ACK/NACK) feedback report, or
a beam management (BM) report, wherein the SI indication is included in a bit at an end of the BM report, a new BM metric, or an existing BM metric in the BM report.
